(19) United States
(12) Patent Application Publication
(10) Pub. No.: US 2013/0054215 A1
(43) Pub. Date: Feb. 28, 2013

(54) SYSTEMS AND METHODS FOR APNEA-ADJUSTED NEUROBEHAVIORAL PERFORMANCE PREDICTION AND ASSESSMENT

(71) Applicants: Michael D. Stubna, Philadelphia, PA (US); Christopher Grey Mott, Seattle, WA (US); Daniel Joseph Mollicone, Philadelphia, PA (US)

(72) Inventors: Michael D. Stubna, Philadelphia, PA (US); Christopher Grey Mott, Seattle, WA (US); Daniel Joseph Mollicone, Philadelphia, PA (US)

(73) Assignee: Pulsar Informatics, Inc., Philadelphia, PA (US)

(21) Appl. No.: 13/598,607

(22) Filed: Aug. 29, 2012

Related U.S. Application Data
(60) Provisional application No. 61/528,341, filed on Aug. 29, 2011.

(51) Int. Cl. G06G 7/60

(52) U.S. Cl. 703/11

(57) ABSTRACT

Human neurobehavioral performance prediction systems and methods are disclosed in which disrupted sleep patterns, such as (without limitation) sleep fracturing due to apnea, are accounted for. Biomathematical models are used to predict neurobehavioral performance based on disrupted sleep using a sleep function modified in accordance with apnea-severity data to account for loss in sleep efficiency. Risk of diminished neurobehavioral performance can then be monitored in affected individuals. Compliance with treatment regimens, adjustments to apnea severity assessment, corrections to predicted future sleep schedules, and/or individualization of neurobehavioral performance model parameters can also be achieved based upon a comparison of actual and model-predicted performance levels.

### RELATED APPLICATIONS

This application claims benefit of the priority of U.S. application No. 61/528,341, filed Aug. 29, 2011.

### TECHNICAL FIELD

The presently disclosed systems and methods relate to systems, methods, and/or devices for predicting neurobehavioral performance, including fatigue and/or alertness states, of a human subject who suffers from a sleep disturbance, such as that caused by sleep apnea, another sleep-disordered breathing condition, or by environmental factors (e.g., noise, vibration, light, etc. in the sleep environment).

### BACKGROUND

Sleep apnea is a sleep-breathing disorder characterized by a period of shallow breathing or a pause in breathing that causes a drop in blood-oxygen saturation. These breathing disruptions during sleep may lead to a nervous system arousal, snoring, restless sleep, daytime sleepiness, or an overall diminished restorative value of sleep. Sleep apnea treatment devices such as a continuous positive airway pressure (CPAP) machine can treat sleep apnea symptoms with high efficacy. Such devices, however, are often found uncomfortable to wear, and some people who are affected with sleep apnea may choose to live with the symptoms rather than wearing a treatment device. Individuals with untreated sleep apnea are generally at a much higher risk for fatigue-related incidents and experience reduced levels of alertness and diminished neurobehavioral performance generally.

Such reduced levels of alertness and/or degraded neurobehavioral performance due to fatigue increase risks of accidents and reduce operational effectiveness, which may be a concern in many operational settings such as transportation, health care, emergency response, and space flight, for example. Current biomathematical models for predicting fatigue or other neurobehavioral characteristics account for neither the effect of certain sleep disorders, such as apnea or other sleep-disordered breathing patterns, nor the treatment of sleep disorders in predicting fatigue-risk. There is therefore a general desire to provide accurate predictions of neurobehavioral performance for individuals that are affected by sleep apnea, other sleep-disordered breathing patterns, or systematically fractured sleep generally, such as routine sleep disturbances due to persistent environmental causes (e.g., noise, vibration, light, and/or the like.).

### SUMMARY

Particular embodiments of the presently disclosed invention assist operational managers and/or other users to predict the neurobehavioral performance of one or more subjects afflicted with apnea or some other breathing-disturbed sleeping pattern. Comparisons of predicted performance and measured performance may then be utilized for one or more of: assessing apnea-treatment program compliance by the subjects, adjusting the subjects' apnea severity data, assessing the effectiveness of predicted sleep modeling that uses an apnea-adjusted sleep function, and individualizing one or more parameters of a neurobehavioral performance model.

One particular aspect of the invention provides a method for predicting neurobehavioral performance of a subject that accounts for the severity of sleep-disordered breathing in the subject, the method comprising: receiving apnea-severity data at the computer, the apnea-severity data being indicative of a severity of sleep-disordered breathing in the subject; receiving apnea-treatment data at the computer, the apnea-treatment data being indicative of one or more sleep-disordered breathing treatments associated with the subject; and predicting the neurobehavioral performance of the subject, the neurobehavioral performance being indicative of the subject's performance capacity for one or more neurobehavioral tasks; wherein predicting the neurobehavioral performance of the subject is based at least in part on applying a neurobehavioral performance model to at least one or more of: the received apnea-severity data and the received apnea-treatment data.

Another particular aspect of the invention provides a system for predicting the neurobehavioral performance of a subject that accounts for the severity of sleep-disordered breathing in the subject, the system comprising: one or more apnea-severity data records, the apnea-severity data records containing data being indicative of a severity of sleep-disordered breathing associated with the subject; one or more apnea-treatment data records, the apnea-treatment data records containing data being indicative of one or more sleep-disordered breathing treatments associated with the subject; a sleep modifier model, the sleep modifier model being capable of generating a modified sleep function, the modified sleep function being indicative of a sleep pattern associated with the subject for a time of interest as affected by a sleep-disordered breathing condition; a neurobehavioral performance model for predicting the neurobehavioral performance of the subject, the neurobehavioral performance of the subject being indicative of the subject's performance capacity for one or more neurobehavioral tasks; wherein the sleep modifier model generates a modified sleep function based at least in part the apnea-severity data records; and wherein the biomathematical performance model predicts the neurobehavioral performance of the subject based at least in part on the modified sleep function.

Another particular aspect of the invention provides a computer program product embodied in a non-transitory medium and comprising computer-readable instructions that, when executed by a suitable computer, cause the computer to perform a method for predicting the neurobehavioral performance of a subject that accounts for the severity of sleep-disordered breathing in the subject, the method comprising: receiving apnea-severity data at the computer, the apnea-severity data being indicative of a severity of sleep-disordered breathing in the subject; receiving apnea-treatment data at the computer, the apnea-treatment data being indicative of one or more sleep-disordered breathing treatments associated with the subject; and predicting the neurobehavioral performance of the subject, the neurobehavioral performance being indicative of the subject's performance capacity for one or more neurobehavioral tasks; wherein predicting the neurobehavioral performance of the subject is based at least in part on applying a neurobehavioral performance model to at least one or more of: the received apnea-severity data and the received apnea-treatment data.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a flow chart of a method for predicting the neurobehavioral performance of an individual affected with apnea, in accordance with a particular embodiment;

FIG. 1B is a flow chart of a method for addressing discrepancies between apnea-adjusted neurobehavioral performance predictions (NBP_{P}) and actual neurobehavioral performance (NBP_{A}), in accordance with a particular embodiment;

FIG. 2A provides a component-level diagram for a system for predicting the neurobehavioral performance of an individual affected with apnea, in accordance with a particular embodiment;

FIG. 2B provides a component-level diagram for a system for addressing discrepancies between predicted neurobehavioral performance and measured neurobehavioral performance, in accordance with particular embodiments;

FIG. 3A is an idealized graph of a subject's sleep state (a so-called “sleep function”) wherein a single apnea event is illustrated as a thin “notch” in an otherwise perfect square wave signal, in accordance with a particular embodiment;

FIG. 3B is a comparative graph of the rates of homeostatic recovery during sleep for both a normal and an apnea-afflicted subject, in accordance with a particular embodiment;

FIG. 4 is a plot showing the variation of the homeostatic process of a typical subject over the transitions between being asleep and awake, in accordance with a particular embodiment;

The multiple views of FIG. 5 provide a series of plots illustrating modified sleep functions over a sleep session of one hour, in accordance with particular embodiments, wherein:

The modified sleep function of FIG. 5A corresponds to a subject with an apnea-hypopnea index of 0 for the one-hour sleep session;

The modified sleep function of FIG. 5B corresponds to a subject with an apnea-hypopnea index of 5 for the one-hour sleep session;

The modified sleep function of FIG. 5C corresponds to a subject with an apnea-hypopnea index of 25 for the one-hour sleep session; and

The modified sleep function of FIG. 5D corresponds to a subject with an apnea-hypopnea index of 45 for the one-hour sleep session;

The multiple views of FIG. 6 provide a set of plots showing neurobehavioral performance predictions in the form of fatigue-risk scores for different severity levels of sleep apnea determined by utilizing the modified sleep functions illustrated in the corresponding multiple views of FIG. 5, in accordance with particular embodiments;

The multiple views of FIG. 7 provide a set of plots showing neurobehavioral performance predictions in the form of fatigue-risk sores for different severity levels of sleep apnea determined by modifying the parameters of a biomathematical performance model, in accordance with a particular embodiment;

The multiple views of FIG. 8 provide daily average fatigue-risk scores as calculated by various embodiments, particularly in which:

FIGS. 8A and 8B provide tables containing examples of calculated daily average fatigue-risk scores determined by using modified sleep functions as input to a biomathematical performance model, assuming a ten-hour work day (FIG. 8A), and a twelve-hour work day (FIG. 8B), in accordance with particular embodiments; and

FIG. 8C is a table showing an example of calculated daily average fatigue-risk scores determined by modifying the parameters of a fatigue model, assuming a ten-hour work day, in accordance with particular embodiments.

### DETAILED DESCRIPTION

Throughout the following discussion, specific details are set forth in order to provide a more thorough understanding of the disclosed invention. The invention, however, may be practiced without these particulars. In other instances, well-known elements have not been shown or described in detail to avoid unnecessarily obscuring the invention. Accordingly, the specification and drawings are to be regarded in an illustrative capacity, rather than in a restrictive sense.

Background to Apnea

An apnea is defined as a cessation in breathing that lasts ten (10) seconds or longer and often occurs during sleep. So-called sleep apnea is typically classified into at least three categories—central-type apnea, obstructive-type apnea, and mixed-type apnea. It is generally understood that central-type apnea is caused by a neurological abnormality in the respiratory control center of the brain brought about by any number of other conditions, including a head injury, stroke, heart failure, or other disorder of the nervous system. It is also widely understood that obstructive-type apnea is caused by a morphological abnormality in the upper airway tract, such as tonsillar hypertrophy or micrognathia, or by a tonus of the upper airway muscle for broadening the airway. (Little agreement exists as to the causes of the less common mixed-type apnea.) Among its many aims and objectives, the presently disclosed invention is designed to predict and assess the neurobehavioral performance of an individual suffering from loss of sleep efficiency due to apnea (or other similar conditions or external factors), and is designed to do so independently of the type of apnea involved or its physiological basis or cause.

Severity of sleep apnea (regardless of type) is commonly gauged according to a widely accepted apnea-hypopnea index (“AHI”), which is a simple count of the number of apnea events (lasting 10 seconds or longer) observed in a subject per hour. See, e.g., Magalgang, U. J., et al. “Prediction of the Apnea-Hypopnea Index from Overnight Pulse Oximetry,” Chest 124:5 pp. 1694-1701 (Am. Col. Chest Physicians 2003). Other standards for assessing apnea severity exist as well, including various sleep-disturbance indexes (“SDI”), the Pittsburgh sleep quality index (“PSQI”) scales, quantitative and/or numerical subjective severity assessments (e.g. “high,” medium” or low” and/or a rating from 1 to 10, etc.) and/or the like. See, e.g., Griefahn, B., et al. “Development of a sleep disturbance index (SDI) for the assessment of noise induced sleep disturbances,” Somnologie—Schlafforschung and Schlafmedizin, 12:2 pp. 150-157 (Springer Verlag 2008); Buysse, D. J., et al. “The Pittsburgh sleep quality index: A new instrument for psychiatric practice and research,” Psychiatry Research, 28:2 pp. 193-213 (Reed Elsevier 1989). Particular embodiments of the invention may make use of any one or more of the sleep-disturbance and sleep-efficiency measurement techniques described in the aforementioned references or various combinations and/or equivalents thereof. All of the publications referred to in this paragraph are hereby incorporated by reference herein.

Non-limiting examples of treatment methodologies for apnea include behavioral therapy (e.g., sleep time and position modification, avoiding alcohol, etc.), medications (e.g. Acetazolamide), use of oral appliances (so-called oral appliance therapy), continuous positive airway pressure (“CPAP”) and its variants (APAP, BiPAP, etc.), surgery, and/or the like. Continuous positive airway pressure or CPAP (also denoted C_{PAP}) is the most common form of apnea treatment and involves the use of continuous air pressure flowing inwardly into the subject's airway (i.e., in the so-called “positive direction”). Briefly stated, CPAP treatment acts as a pneumatic splint of the airway by the provision of a positive pressure, usually in the range 4-20 cm H₂0. The air is supplied to the airway by a motor-driven blower whose outlet passes via an air delivery hose to a nose and/or mouth mask engaged to a patient's face by removable seal. An exhaust port is typically provided in the delivery tube proximate to the mask. U.S. Pat. No. 7,364,140 provides an example of a common CPAP device. More sophisticated forms of CPAP, such as bi-level CPAP (so-called BiPAP) and autosetting CPAP (so-called APAP), are described in U.S. Pat. Nos. 5,148,802 and 5,245,995 respectively.

Various techniques are known for sensing and detecting abnormal breathing patterns indicative of obstructed breathing. U.S. Pat. No. 5,245,995, for example, also describes how snoring and abnormal breathing patterns can be detected by inspiration and expiration pressure measurements while sleeping, thereby leading to early indication of pre-obstructive episodes or other forms of breathing disorder. Particularly, patterns of respiratory parameters are monitored, and CPAP pressure is raised on the detection of pre-defined patterns to provide increased airway pressure, ideally, to subvert the occurrence of the obstructive episodes and the other forms of breathing disorder. Particular embodiments of the invention may make use of any one or more of the devices or technologies described in the aforementioned references or various combinations and/or variations thereof. All of the publications referred to in this and the previous paragraphs are hereby incorporated by reference herein.

As used herein the term “apnea” shall refer not only to obstructive, general, or mixed-type sleep apneas, but also to any sleep-disordered breathing pattern that causes sleep to be less efficient. Broadly defined herein, “apnea” tends to cause difficulties in the sufferer's ability to perform basic neurobehavioral tasks while awake because fractured sleep tends to affect alertness levels and/or the body's ability to utilize properly the homeostatic decay/build-up process as would be the case with more typical or “normal” sleep patterns. Among its many aims and objectives, the presently disclosed invention is directed (without limitation) toward assessing, predicting, and managing the neurobehavioral performance of individuals affected by apnea and/or other disrupted sleep patterns.

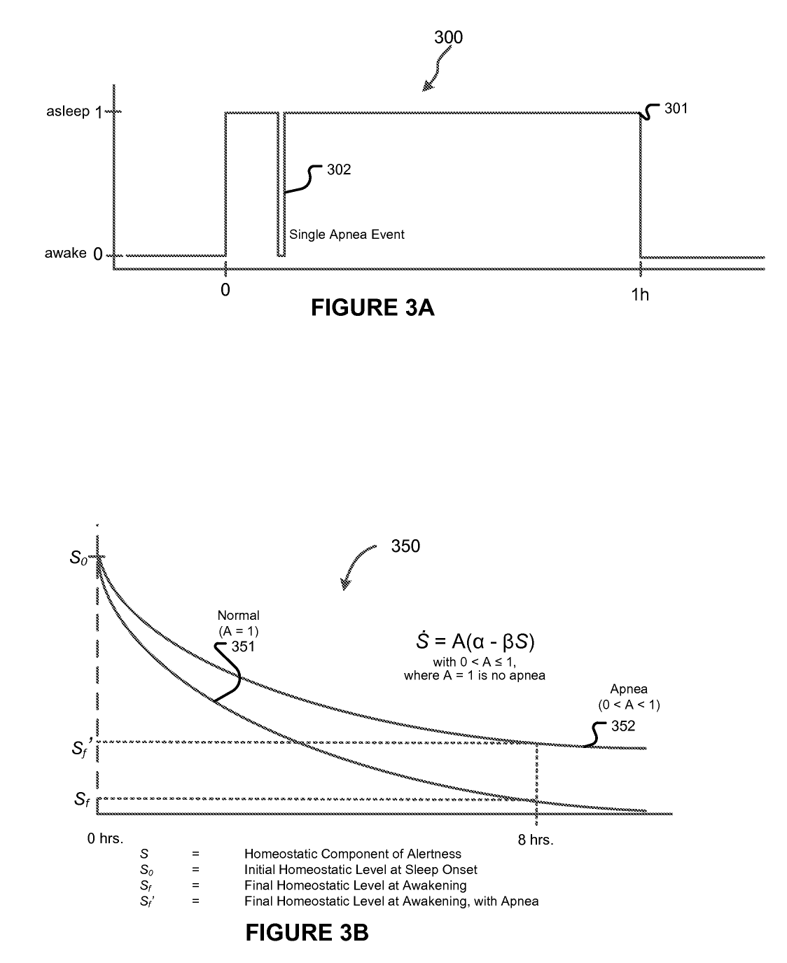

Particular embodiments may also be utilized to predict, manage, and/or monitor neurobehavioral performance in individuals who, while not suffering from apnea or another specific physiological sleep-disordered breathing condition, nonetheless experience disrupted sleeping patterns for a variety of reasons, including but not limited to disturbance events within the sleeping environment, medications, stress and anxiety, and/or the like. Sleep disturbance events, which tend to cause one or more brief wake episodes, may be caused by (without limitation) loud noises in the sleeping environment, sleeping environments subjected to mechanical or other vibrations (e.g., commercial trucks, seagoing vessels, space-craft, residential homes near heavy industrial activity or airports, etc.), ambient light, personnel or other “intruders” into the sleep environment (e.g., medical personnel in a hospital suite or sleep lab, etc.), and/or the like. For the sake of the present discussion and the appended claims, the term “apnea” shall be construed to cover any disturbed sleep pattern—whether physiological in nature or originating from environmental causes—that may be suitably modeled by a sleep function modified in accordance with the disclosed techniques and/or methods (see, e.g., FIGS. 3 and 5).

Background to Neurobehavioral Performance

Aspects of the presently disclosed invention relate to various features and details of neurobehavioral performance. Broadly defined, “neurobehavioral performance” refers to an individual's ability to perform a specific task that requires one or more cognitive functions that rely on alertness level and/or fatigue state. Such cognitive functions include (without limitation) concentration, short-term or long-term memory, visual or other sensory acuity, alertness, gross motor dexterity, fine motor skill, and/or the like. As used herein, the terms (used interchangeably) “neurobehavioral performance prediction(s),” “predicted neurobehavioral performance,” and “predicted neurobehavioral performance level(s)” refer to the output of a biomathematical model capable of modeling and/or predicting neurobehavioral performance states when given appropriate inputs. Non-limiting factors that may impact a subject's neurobehavioral performance include: sleep disruption, sleep restriction, circadian misalignment, sleep inertia, extended task performance, extended work/duty hours, multitasking, (extended) physical exertion, psychological stresses (e.g., time pressure; family, financial, or legal issues etc.), environmental stressors (e.g., extreme temperature or humidity conditions, ambient noise, ambient vibration, ambient light conditions, altitude “hypoxia” etc.), certain medical conditions or behavioral disorders (e.g., Parkinson's, Alzheimer's, dementia, or any age-related brain dysfunction or mild cognitive impairment, brain injuries, mood disorders, and certain psychoses, etc.), certain drugs, and/or the like.

Methods to Test Neurobehavioral Performance Generally

The presently disclosed invention may make use of any methods or techniques used to measure neurobehavioral performance. Such methods and techniques may include context-relative performance tasks, such as a workplace-specific task (e.g., assembling X number of specific product units in a particular factory in time T and/or the like), standardized line-of-work specific tasks (e.g., typing a standard document within an acceptable accuracy threshold on standard equipment, and/or the like), and so-called “special tasks” that highlight particular neurobehavioral performance characteristics (e.g., executing a specific complex driving, flying, or navigation maneuver within an acceptable threshold, navigating a standardized obstacle course on foot, assembling a particular standardized complex manufactured object, and/or the like). Performance measures for such neurobehavioral tasks may come from direct human observation, measurement instruments, or from embedded systems (e.g., a lane tracking system on a commercial motor vehicle). In medical monitoring, screening, diagnosis and treatment settings neurobehavioral assessment may be made based on physician or medical-care-provider observation or standard instruments used in the field such as (without limitation): the Mini-Mental State Examination (MMSE), the Mini-Cog Test, the Alzheimer's Disease Assessment Scale-cognitive (ADAS-cog), Ammons Quick Test, National Adult Reading Test (NART), Wechsler Adult Intelligence Scale (WAIS), Wechsler Intelligence Scale for Children (WISC), Wechsler Preschool and Primary Scale of Intelligence (WPPSI), Wechsler Test of Adult Reading (WTAR), California Verbal Learning Test, Cambridge Prospective Memory Test (CAMPROMPT), Doors and People, Memory Assessment Scales (MAS), Rey Auditory Verbal Learning, Test Rivermead Behavioral Memory Test, Test of Memory and Learning (TOMAL), Test of Memory Malingering (TOMM), Wechsler Memory Scale (WMS), Boston Diagnostic Aphasia Examination, Boston Naming Test, Comprehensive Aphasia Test, Lexical Decision Task, Multilingual Aphasia Examination, Behavioral Assessment of Dysexecutive Syndrome (BADS), CogSreen: Aeromedical Edition, Continuous Performance Task (CPT), Controlled Oral Word Association Test (COWAT), d2 Test of Attention, Delis-Kaplan Executive Function System (D-KEFS), Digit Vigilance Test Figural Fluency Test, Halstead Category Test, Halying and Brixton Tests, Iowa Gambling Test, Kaplan Baycrest Neurocognitive Assessment (KBNA), Kaufman Short Neuropsychological Assessment, Paced Auditory Serial Addition Test (PASAT), Pediatric Attention Disorders Diagnostic Screener (PADDS), Ruff Figural Fluency Test, Stroop Task, Test of Variables of Attention (TOVA), Tower of London Test, Trail Making Test (TMT), Trails A & B, Wisconsin Card Sorting task (WCST), Symbol Digit Modalities Test, Clock Test, Hooper Visual Organization Task (VOT), Rey-Osterrieth Complex Figure, Clinical Dementia Rating, Dementia Rating Scale, MCI Screen, Cambridge Neuropsychological Test Automated Battery (CANTB), The Neurobehavioral Cognitive Status Examination (Cognistat), Cognitive Assessment Screening Instrument, CNS Vital Signs (CNSVS), Cognitive Function Scanner (CFS), Dead-Woodcock Neuropsychology Assessment System (DWNAS), General Practitioner Assessment of Cognition (GPCOG), Hooper Visual Organization Test, Luria-Nebraska Neuropsychological Battery, A Developmental Neuropsychological Assessment (NEPSY), Repeatable Battery for the Assessment of Neuropsychological Status, CDR Computerized Assessment System, and/or the like.

Furthermore, performance assessment on one or more neurobehavioral tasks may be measured by one or more standard tests including but not limited to: the Psychomotor Vigilance Test (PVT), the Motor Praxis Test (MPraxis), the Visual Object Learning Test (VOLT), the Fractal-2-Back Test (F2B), the Conditional Exclusion Task (CET), the Matrix Reasoning Task (MRsT), the Line Orientation Test (LOT), the Emotion Recognition Task (ER), the Balloon Analog Risk Task (BART), the Digit Symbol Substitution Test (DSST), the Forward Digit Span (FDS), the Reverse Digit Span (BDS), the Serial Addition and Subtraction Task (SAST), the Go/NoGo Task, the Word-Pair Memory Task, the Word Recall Test (Learning,Recall), the Motor Skill Learning Task, the Threat Detect Task, the Descending Subtraction Task (DST), the Positive Affect Negative Affect Scales-Extended version (PANAS-X) Questionnaire, the Pre-Sleep/Post-Sleep Questionnaires for astronauts, the Beck Depression Inventory (BDI), the Conflict Questionnaire, Karolinska Drowsiness Test (KDT), the Visual Analog Scales (VAS), the Karolinska Sleepiness Scale (KSS), the Profile of Mood States Long/Short Form Questionnaire (POMS/POMS SF), the Stroop Test, and/or the like.

Methods to Test Fatigue Specifically

Although the presently disclosed invention may be used to monitor and to assess an apnea-afflicted individuals' neurobehavioral performance generally, particular embodiments are specifically directed to the management and assessment of neurobehavioral deficits of apnea-afflicted individual that are related to fatigue. Embodiments of the presently disclosed invention may make use of one or more techniques for measuring or testing an individual's fatigue levels (referred to hereinafter as “fatigue-measurement techniques”). Particular embodiments of the invention are sufficiently adaptable to utilize many (if not all) of these known fatigue-measurement techniques. Non-limiting and non-mutually exclusive examples of suitable fatigue-measurement techniques which may be used in various embodiments of the invention include testing techniques which use: (i) objective reaction-time tasks, stimulus-response tests, and cognitive tasks such as the Psychomotor Vigilance Task (PVT) or variations thereof (Dinges, D. F. and Powell, J. W. “Microcomputer analyses of performance on a portable, simple visual RT task during sustained operations” Behavior Research Methods, Instruments, & Computers 17(6): 652-655, 1985) and/or a so-called digit symbol substitution test; (ii) subjective alertness, sleepiness, or fatigue measures based on questionnaires or scales such as (without limitation) the Stanford Sleepiness Scale, the Epworth Sleepiness Scale (Jons, M. W., “A new method for measuring daytime sleepiness—the Epworth sleepiness scale” Sleep 14 (6): 54-545, 1991), and the Karolinska Sleepiness Scale (Åkerstedt, T. and Gillberg, M. “Subjective and objective sleepiness in the active individual” International Journal of Neuroscience 52: 29-37, 1990); (iii) EEG measures and sleep-onset-tests including (without limitation) the Karolinska drowsiness test (Åkerstedt, T. and Gillberg, M. “Subjective and objective sleepiness in the active individual” International Journal of Neuroscience 52: 29-37, 1990), Multiple Sleep Latency Test (MSLT) (Carskadon, M. W. et al., “Guidelines for the multiple sleep latency test—A standard measure of sleepiness” Sleep 9 (4): 519-524, 1986) and the Maintenance of Wakefulness Test (MWT) (Mitler, M. M., Gujavarty, K. S. and Browman, C. P., “Maintenance of Wakefulness Test: A polysomnographic technique for evaluating treatment efficacy in patients with excessive somnolence” Electroencephalography and Clinical Neurophysiology 53:658-661, 1982); (iv) physiological measures such as (without limitation) tests based on blood pressure and heart rate changes, and tests relying on pupillography and/or electrodermal activity (Canisius, S. and Penzel, T., “Vigilance monitoring—review and practical aspects” Biomedizinische Technik 52(1): 77-82., 2007); (v) embedded performance measurement systems, devices, and processes such as (without limitation) devices that are used to measure a driver's performance in tracking the lane marker on the road (see, e.g., U.S. Pat. No. 6,894,606); and (vi) simulators that provide a virtual environment to measure specific task proficiency such as commercial airline flight simulators (Neri, D. F., Oyung, R. L., et al., “Controlled breaks as a fatigue countermeasure on the flight deck” Aviation Space and Environmental Medicine 73(7): 654-664, 2002); and/or (vii) the like. Particular embodiments of the invention may make use of any one or more of the fatigue-measurement techniques described in the aforementioned references or various combinations and/or equivalents thereof. All of the publications referred to in this paragraph are hereby incorporated by reference herein.

Models for Predicting Neurobehavioral Performance

The presently disclosed invention is designed to utilize any biomathematical model designed generally to model any one or more of human subject's neurobehavioral performance characteristics. Such biomathematical models are referred to herein as “neurobehavioral performance models.” Particular embodiments are specifically designed to utilize biomathematical models that model a human subject's alertness and/or fatigue state. Such biomathematical models are referred to herein as “fatigue models.” As used herein, the terms “biomathematical model(s),” “neurobehavioral performance model(s),” and “fatigue model(s)” shall have the following relationship: fatigue models are a subset of neurobehavioral performance models (fatigue and/or alertness being a type of neurobehavioral performance), and neurobehavioral performance models are, in turn, a subset of biomathematical models.

Among the neurobehavioral performance models utilized by the presently disclosed invention, particular embodiments may utilize the so-called “two-process model” of sleep regulation developed by Borbèly et al. in 1999. The Borbèly two-process model posits the existence of two primary regulatory mechanisms: (i) a sleep/wake-related mechanism that builds up exponentially during the time that the subject is awake and declines exponentially during the time that the subject is asleep, and is called the “homeostatic process” or “process S;” and (ii) an oscillatory mechanism with a period of (nearly) 24 hours, called the “circadian process” or “process C.” Without wishing to be bound by theory, the circadian process has been demonstrated to be orchestrated by the suprachiasmatic nuclei of the hypothalamus. The neurobiology of the homeostatic process is only partially known and may involve multiple neuroanatomical structures. Total alertness at a given time y(t), which is one non-limiting example of neurobehavioral performance, may then be represented as a sum of the C and S processes (see Equation 3, below).

Further details related to the application of the Borbèly two-process fatigue model are contained in PCT published patent application Systems and Methods for Individualized Alertness Predictions, inventors Mott C. G., Mollicone, D. J., et al., WIPO publication No. WO 2009/052633, the entirety of which is incorporated herein by reference and from which portions of the following discussion are excerpted for convenience and clarity.

Specifically, in accordance with the two-process model, the circadian process C may be represented by:

$$C ( t ) = γ {\sum }_{l = 1}^{5} {a}_{l} sin ( 2 l π ( t - ϕ ) / τ ) \qquad ( 1 )$$

where t denotes clock time (in hours, e.g. relative to midnight), φ represents the circadian phase offset (i.e. the timing of the circadian process C relative to clock time), γ represents the circadian amplitude, and τ represents the circadian period which may be fixed at a value of approximately or exactly 24 hours. The summation over the index l serves to allow for harmonics in the sinusoidal shape of the circadian process. For one particular application of the two-process model for alertness prediction, l has been taken to vary from 1 to 5, with constants aₗ being fixed at a₁=0.97, a₂=0.22, a₃=0.07, a₄=0.03, and a₅=0.001.

The homeostatic process S may be represented by:

$$S ( t ) = \{ \begin{matrix}{e}^{- {ρ}_{w} Δ t} {S}_{t - Δ t} + ( 1 - {e}^{- {ρ}_{w} Δ t} ) & if during wakefulness ( 2 a ) \\ {e}^{- {ρ}_{w} Δ t} {S}_{t - t Δ} & if during sleep ( 2 b )\end{matrix}$$

(S>0), where t denotes (cumulative) clock time, Δt represents the duration of time step from a previously calculated value of S, ρ_{w} represents the time constant for the build-up of the homeostatic process during wakefulness, and ρₛ represents the time constant for the recovery of the homeostatic process during sleep.

Given equations (1), (2a) and (2b), the total alertness according to the two-process model may be expressed as a sum of: the circadian process C, the homeostatic process S multiplied by a scaling factor κ, and an added noise component ε(t):

y(t)=κS(t)+C(t)+ε(t) (3)

Furthermore, it is useful to be able to describe the homeostatic process S for test subject after one or more transitions between being asleep and being awake. The sleep-wake transitions are commonly (but without limitation) represented as square wave signals oscillating between the binary states of being asleep (value=1 herein, without limitation) and being awake (value=0 herein, without limitation), referred to as sleep functions. As discussed in connection with FIG. 3B, other mathematical representations of sleep status and effectiveness can be utilized by the presently disclosed invention. FIG. 3A and the multiple views of FIG. 5, furthermore, illustrate several ways in which a binary sleep function may be modified to adequately reflect a subject's apnea severity by inserting one or more wake episodes in the form of slender “notches” in a square wave signal.

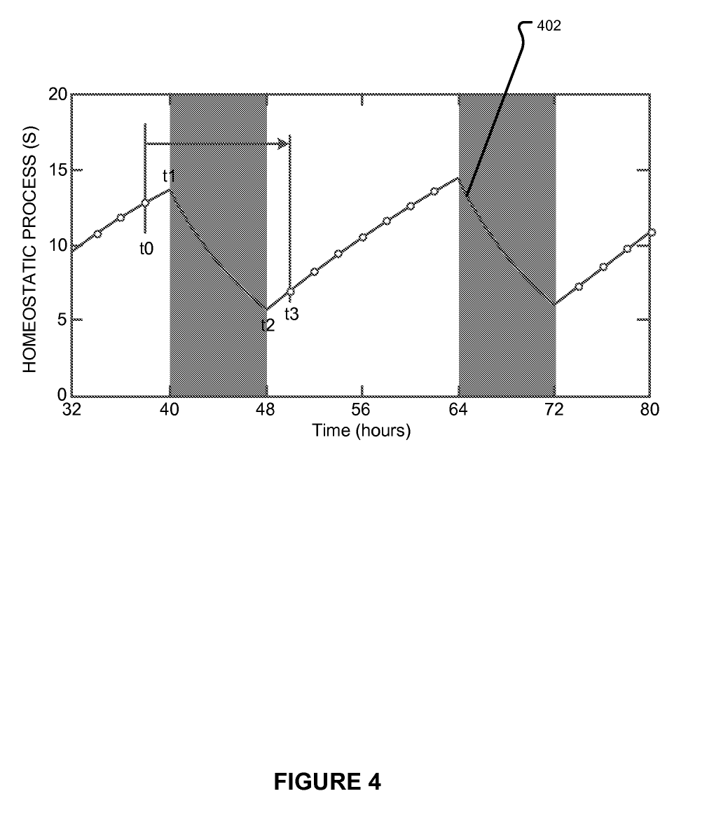

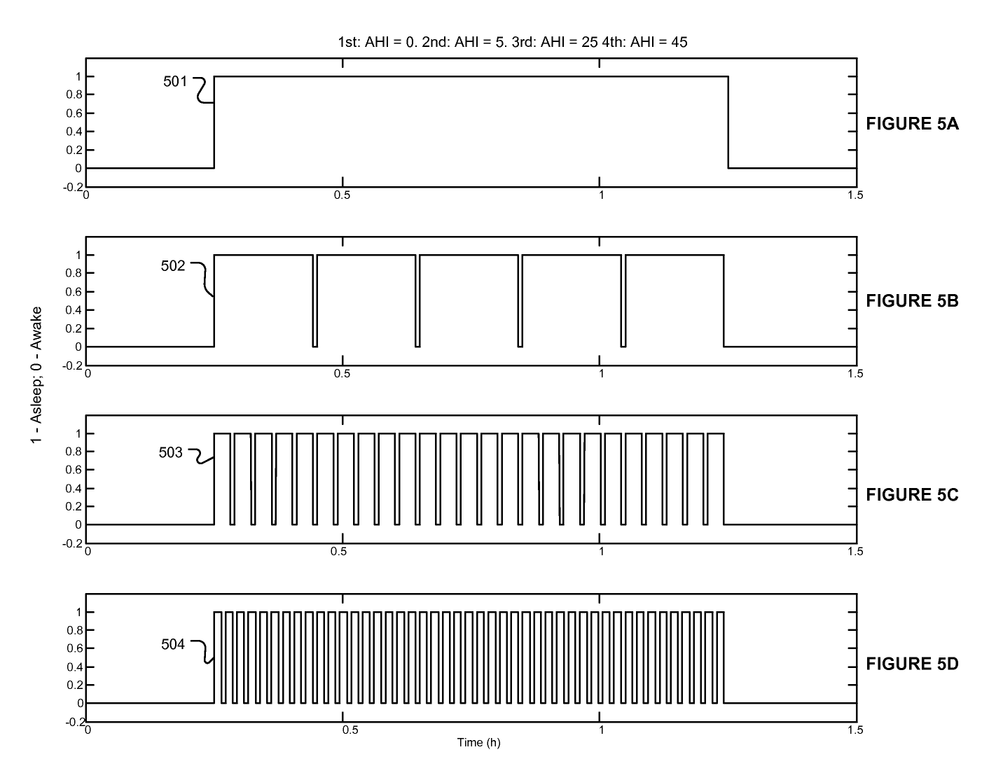

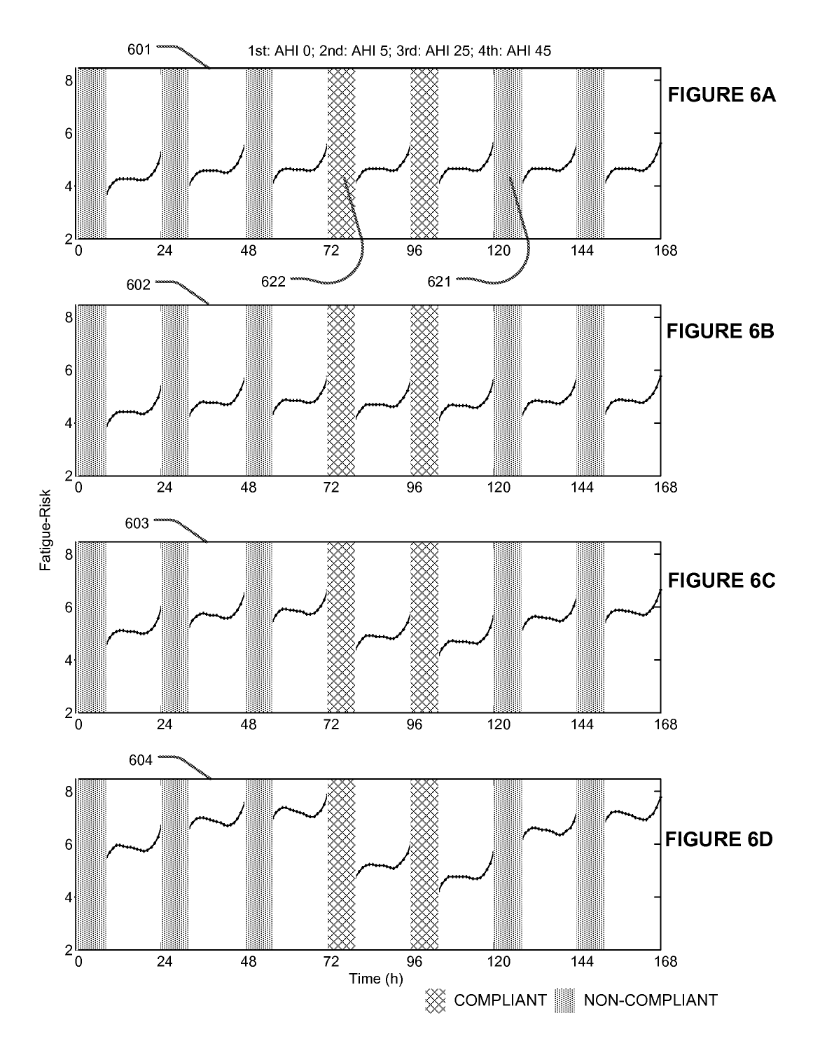

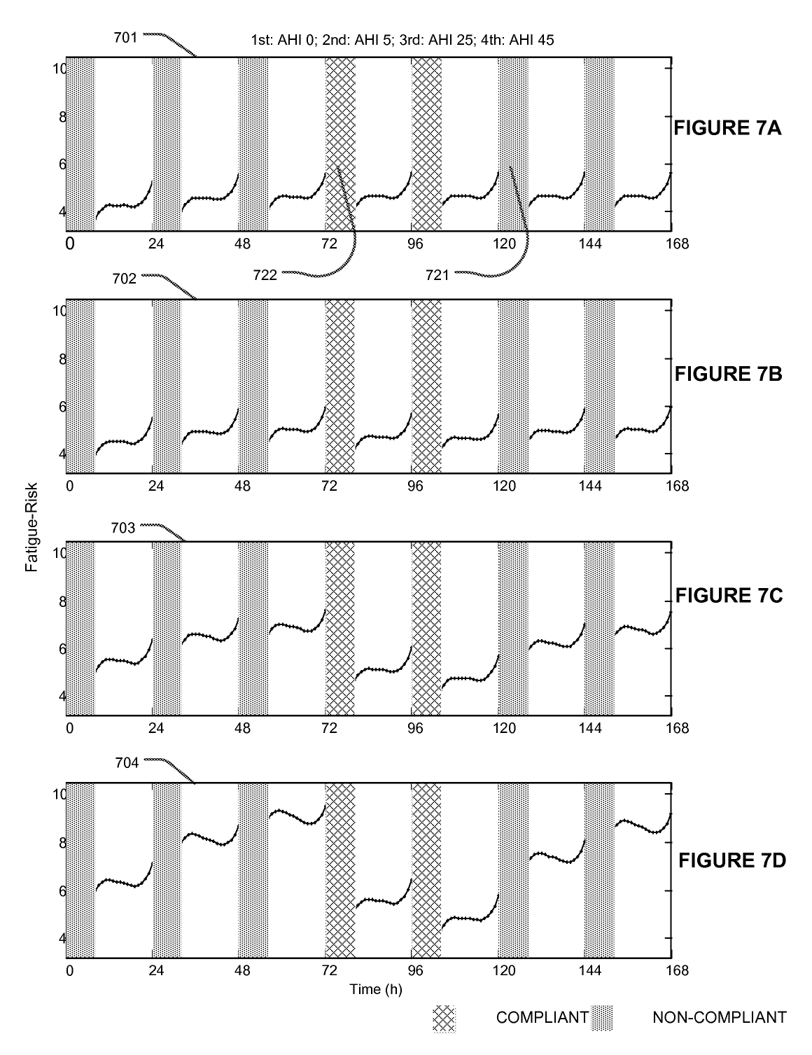

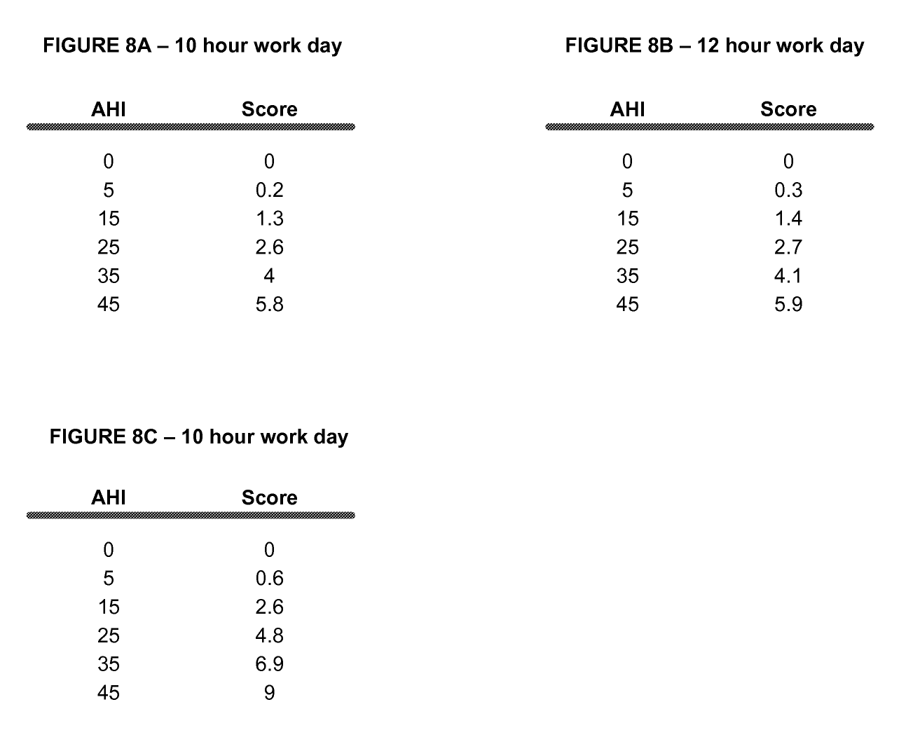

As described in more particular detail below, the systems and methods of the invention may make use of measured neurobehavioral performance levels which is typically only available when the subject is awake. Consequently, it may be desirable to describe the homeostatic process between successive periods that the test subject is awake. As the circadian process C is independent from the homeostatic process S, we may consider as an illustrative case of neurobehavioral performance using only the homeostatic process S of equations (2a), (2b). Consider the period between t₀ and t₃ shown in FIG. 4. During this period, the subject undergoes a transition from awake to asleep at time t₁ and a transition from asleep to awake at time t₂. Applying the homeostatic equations (2a), (2b) to the individual segments of the period between t₀ and t₃ yields:

S(t₁)=S(t₀)e^{-ρ}^{_{w}}^{T}^{₁}+(1−e^{-ρ}^{_{w}}^{T}^{₁}) (4a)

S(t₂)=S(t₁)e^{-ρ}^{ₛ}^{T}^{₂} (4b)

S(t₃)=S(t₂)e^{-ρ}^{_{w}}^{T}^{₃}+(1−e^{-ρ}^{_{w}}^{T}^{₃}) (4c)

Where

T₁=t₁−t₀ (5a)

T₂=t₂−t₁ (5b)

T₃=t₃−t₂ (5c)

Substituting equation (5a) into (5b) and then (5b) into (5c) yields an equation for the homeostat at a time t₃ as a function of an initial known homeostat condition S(t₀), the time constants of the homeostatic equations (ρ_{w}, ρₛ) and the transition durations (T₁, T₂, T₃):

$$\begin{matrix}S ( {t}_{3} ) = {f}_{s} ( S ( {t}_{0} ) , {ρ}_{w} , {ρ}_{s} , {T}_{1} , {T}_{2} , {T}_{3} ) \\ = [ S ( {t}_{0} ) {e}^{- {ρ}_{w} {T}_{1}} + ( 1 - {e}^{- {ρ}_{w} {T}_{1}} ) ] \\ {e}^{- {ρ}_{s} {T}_{2} - {ρ}_{{wT}_{3}}} + ( 1 - {e}^{- {ρ}_{w} {T}_{3}} )\end{matrix} \qquad ( 6 )$$

Equation (6) applies to the circumstance where t₀ occurs during a period when the test subject is awake, there is a single transition between awake and asleep at t₁ (where t₀<t₁<t₃), there is a single transition between asleep and awake at t₂ (where t₁<t₂<t₃), and then t₃ occurs after the test subject is awake again.

Additional fatigue models may be utilized by particular embodiments. Other non-limiting examples of fatigue models include Akerstedt's “three-process model of alertness” (see, e.g., Akerstadt, T., et al. “Predictions from the Three-Process Model of Alertness,” Aviation, Space, and Environmental Medicine, 75:No. 3, § II (March 2004); see also Akerstedt, T. et al. “A Model of Human Sleepiness,” excerpted from Sleep '90 J. Horne, Ed. (Pontenagel Press 1990)); Achermann's “two-process model revisited” (see e.g., Achermann, P., “The Two-Process Model of Sleep Regulation Revisited,” Aviation, Space, and Environmental Medicine, 75:No. 3, § II (March 2004)); Avinash's “process-U model” (see Avinash, D., “Parameter Estimation for a Biomathematical Model of Psychomotor Vigilance Performance under Laboratory Conditions of Chronic Sleep,” Sleep-Wake Research in the Netherlands 16:39-42 (Dutch Society for Sleep-Wake Research 2005); Beersma's “modified two-process model” (see, e.g., Beersma, D. G. M., “Models of Human Sleep Regulation,” Sleep Medicine Reviews 2:No. 1, pp. 31-43 (W.B. Saunders Co. Ltd. 1998)); Belyavin and Spencer's “QinetiQ Approach” (see, e.g., Belyavin, A. J. and Spencer, M. B., “Modeling Performance and Alertness: the QinetiQ Approach,” Aviation, Space, and Environmental Medicine, 75:No. 3, § II (March 2004)); the “circadian alertness simulator” (see, e.g., Dijk, D. J., et al. “Fatigue and Performance Models: General Background and Commentary on the Circadian Alertness Simulator for Fatigue Risk Assessment in Transportation,” Aviation, Space, and Environmental Medicine, 75:No. 3, § II (March 2004)); the so-called “new model class” (see, e.g., McCauley, P., et al, “A new mathematical model for the homeostatic effects of sleep loss on neurobehavioral performance,” Journal of Theoretical Biology, 256:227-239 (Reed-Elsevier 2009)); alternative models such as nonparametric approaches and neural networks (see, e.g., Reifman, J., “Alternative Methods for Modeling Fatigue and Performance,” Aviation, Space, and Environmental Medicine, 75:No. 3, § II (March 2004)); and/or the like. Particular embodiments of the presently disclosed invention may make use of any one or more of the biomathematical models described in the aforementioned references or various combinations and/or equivalents thereof. All of the publications referred to in this paragraph are hereby incorporated by reference herein.

The presently disclosed invention may utilize one or more of the foregoing biomathematical models to predict neurobehavioral performance levels when certain inputs are provided. Particular embodiments may focus on fatigue and/or alertness as the specific neurobehavioral characteristic being measured and/or assessed.

The Figures

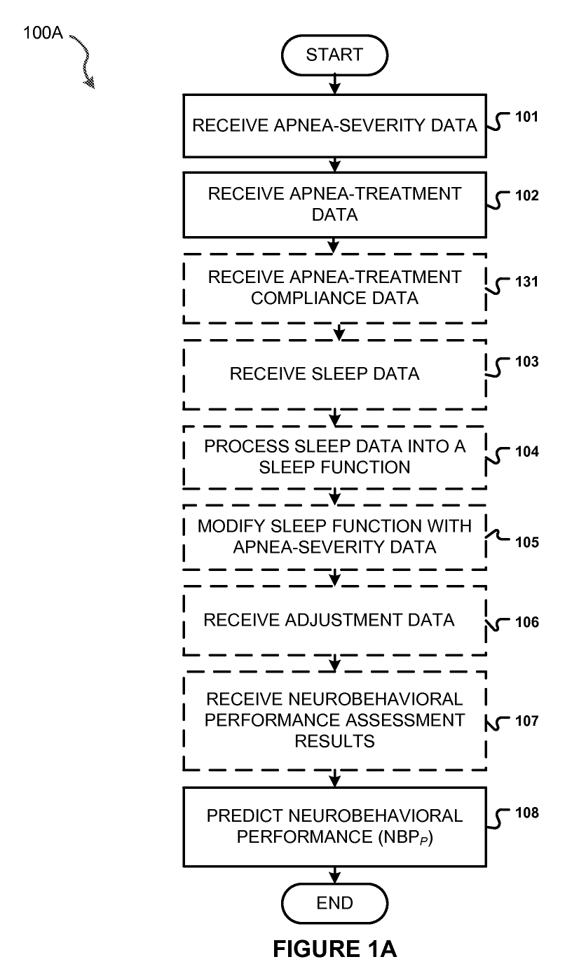

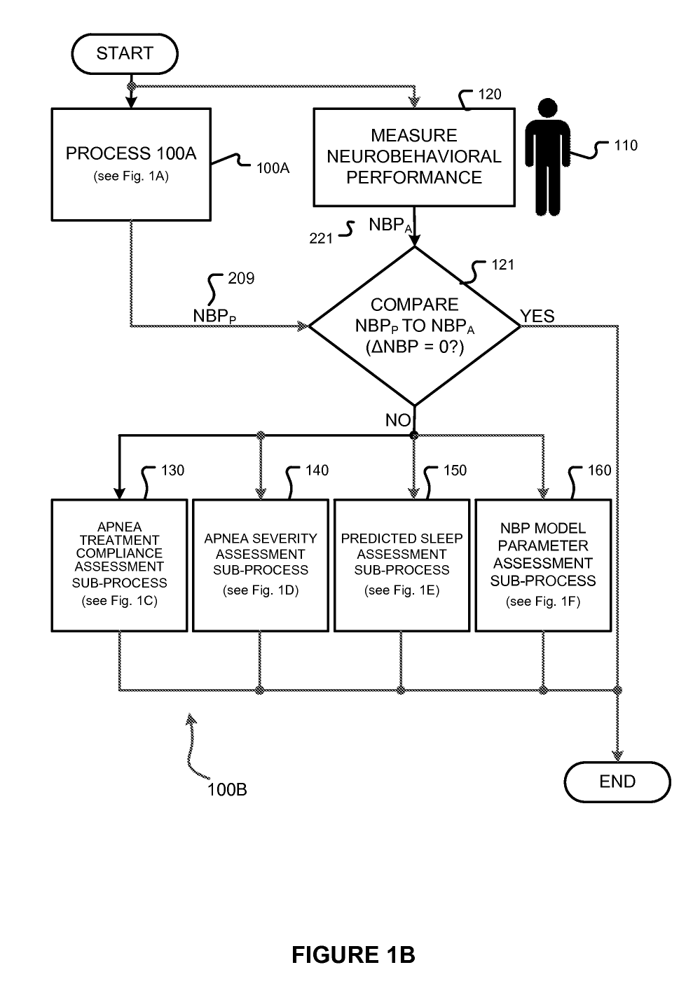

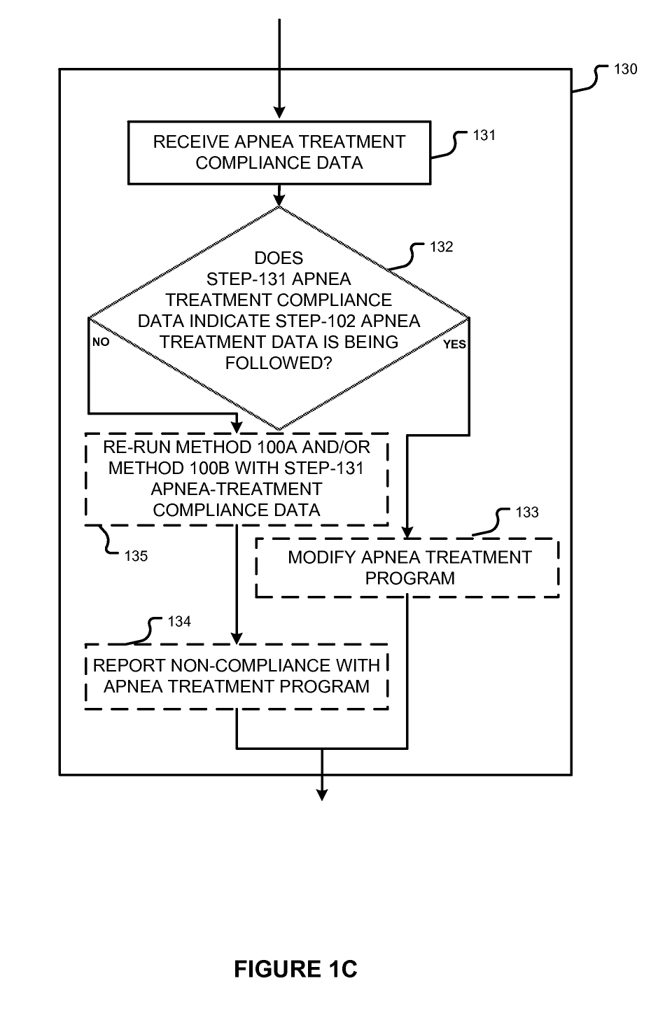

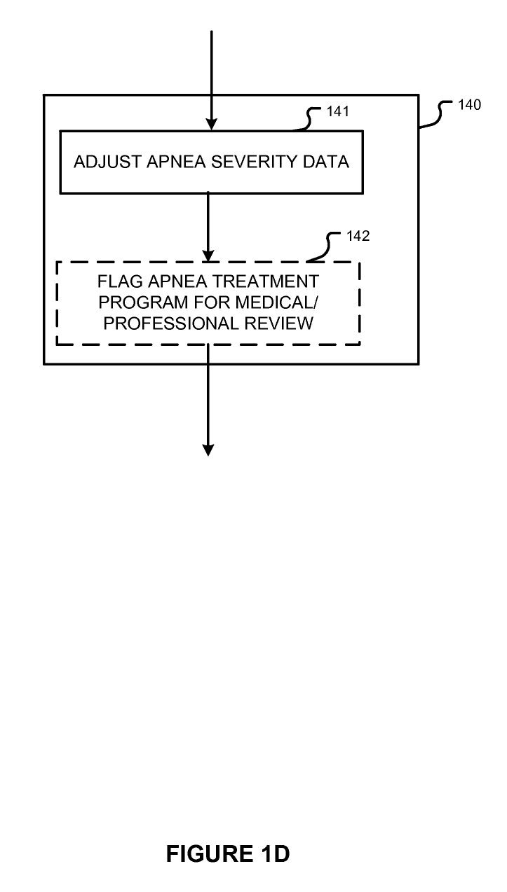

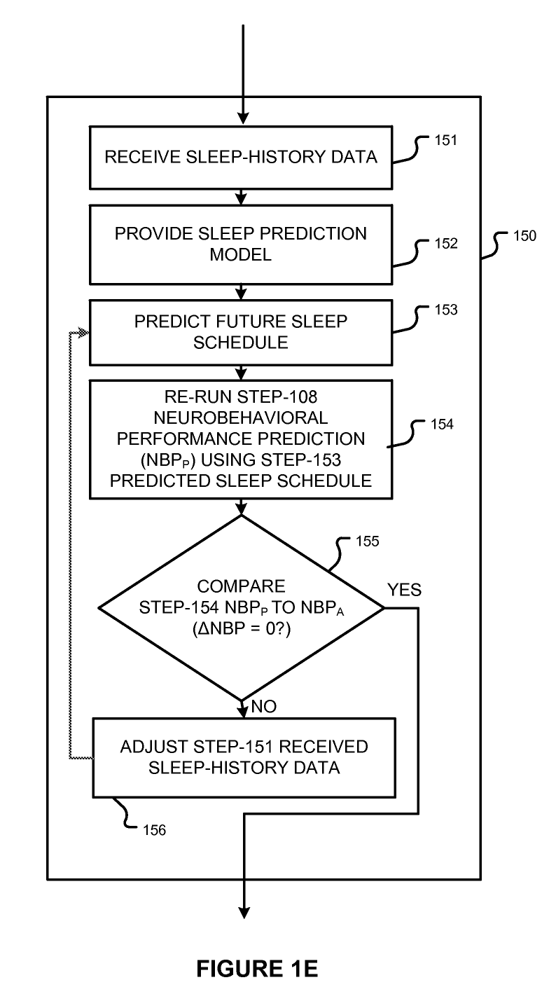

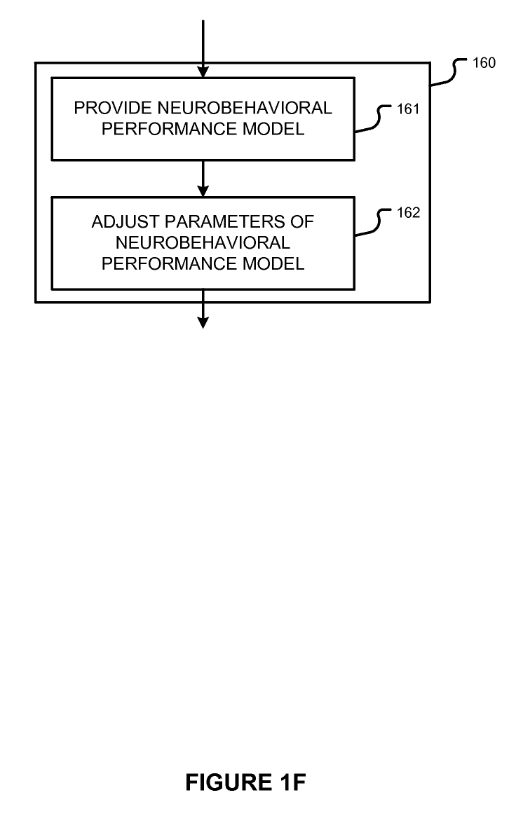

With the foregoing Borblèy two-process model in mind as a non-limiting example of a biomathematical model, the appended drawings illustrate various embodiments, features, systems, and/or methods of the presently disclosed invention. To with, FIG. 1A provides a flowchart for a method 100A to predict neurobehavioral performance in individuals affected by apnea, in accordance with particular embodiments. Method 100A commences with step 101 in which apnea-severity data is received at a processor. Step-101 received apnea-severity data may comprise one or more of AHI, SDI, PSQI, a qualitative and/or quantitative subjective severity assessments, and/or the like. Step-101 received apnea-severity data may be received from a polysomnography system, an oximetry system, an electroencephalography system, user input, a database, a computer system, a network, and/or the like.

According to some embodiments, the severity of an apnea condition may also be determined by the assessment of results from particular neurobehavioral tests (e.g., trends in PVT lapses over a multi-week period) or other neurobehavioral assessments (e.g., continued failure to perform a basic work-related task, etc.). In such embodiments step-101 received apnea-severity data may therefore also comprise one or more results from neurobehavioral tests or other neurobehavioral performance assessments, collected at once or throughout a time period or interval of interest.

In step 102 apnea-treatment data is received. Apnea-treatment data may comprise schedule details (e.g., time, duration, use/nonuse status, device type, and/or the like) for use of a CPAP or other device (e.g., BiPAP, APAP, OAT, etc.), instructions to modify one or more of sleep position, sleep inclination (e.g., legs raised, legs lowered, etc.), sleep duration (i.e., 10 instead of 8 hours per night) or sleep times (i.e., changes to time-to-bed or “bedtimes”), a prescription for medications, restrictions on stimulants, and/or the like. According to particular embodiments, step-102 received apnea-treatment data may be received from one or more of: a continuous positive airway pressure (CPAP) device or system, an automatic positive airway pressure (APAP) device or system, a bi-level positive airway pressure (BiPAP) device or system, an oral appliance therapy (OAT) device or system, an oximetry system, an electroencephalography system, user input, a database, a computer system, a network, and/or the like.

In optional step 131, apnea-treatment compliance data is received at the processor, according to embodiments where apnea-treatment compliance data is available. Step-131 received apnea-treatment compliance data includes any information about the behavior of subject 110 that would assist in determining whether subject 110 is complying with a prescribed course of apnea treatment. Step-131 apnea-treatment compliance data may comprise (without limitation) use history data for a CPAP or other device (e.g., BiPAP, APAP, OAT, etc.), sleep modification history data (i.e., changes to time, location, duration, inclination i.e. “degrees of verticality,” posture, and/or the like of the sleep of subject 110), medication use history data, stimulant consumption history data, and/or the like. Several apnea treatment devices provide for the automatic collection of treatment data, such as how long the device was powered on and how long the device was applied to the wearer—see, e.g., U.S. Pat. No. 6,135,106 to Dirks et al. for “CPAP Pressure and Flow Transducer” for a non-limiting example of such compliance-data collecting devices. Step-131 received apnea-treatment compliance data may be received from such devices.

In optional step 103, sleep data may be received at the processor. Optional step-103 received sleep data comprises any information related to a sleep pattern of a subject, such as (without limitation) the projected sleep schedule, the actual sleep history, or any other particulars pertaining to the sleep state (e.g., location, position, inclination, etc.) of the subject 110. Non-limiting examples of optional step-103 received sleep data include sleep schedules, sleep log or sleep journal entries, actigraphy from which sleep state has been (or can be) determined, audiovisual monitoring of the subject's sleep environment, and/or the like.

In optional step 104 the optional step-103 received sleep data may be processed into a sleep function. An optional step-104 processed sleep function represents the sleep state of subject 110 over a time period of interest and may comprise any mathematical form capable of expressing such a representation. In particular embodiments, the step-104 sleep function is a two-valued square wave signal, where the first value (e.g., value=1) represents a sleep state of the subject 110 of being “asleep” and the second value (e.g., value=0) represents a sleep state of the subject 110 of being “awake.” FIG. 3A provides a non-limiting illustration of such a step-104 sleep function in the form of square wave signal 301.

In other embodiments, the step-104 sleep function comprises a rate of recovery \dot{S}(t) of the homeostatic component of alertness. FIG. 3B provides a non-limiting illustration of such an optional step-104 sleep function in the form of a decaying function 351 of the form \dot{S}(t)=α−βS, where α and β are arbitrary constants, and S represents the homeostatic component of alertness. Other embodiments may utilize any equivalent optional step-104 sleep functions to those shown in FIGS. 3A and 3B as are known in the art.

In optional step 105 the optional step-104 sleep function may be modified according to the step-101 received apnea-severity data. Optional step-105 modification of the optional step-104 sleep function may occur in any fashion that accounts for the loss of sleep efficiency by subject 110 because of a sleep-disturbed breathing condition reflected in the step-101 received apnea-condition data. In particular embodiments, the step-104 sleep function modified in step 105 may have its modification offset by step-102 received apnea treatment data and/or optional step-131 received apnea-treatment compliance data.

In particular embodiments, optional step 105 modifies the optional step-104 sleep function by inserting short intervals of wake periods (so-called “notches”) into longer sleep intervals contained in step-104 sleep functions comprising two-valued square wave signals. Wake period 351 of FIG. 3A illustrates the insertion of such a notch 302 into a step-104 sleep function 301.

In other embodiments, optional step-105 modification of optional step-104 sleep functions occurs by modifying the rate of homeostatic recovery by a modification factor, A, proportional to the severity of the sleep-disturbed condition represented in the step-101 apnea-severity data. By way of non-limiting example, modified sleep function 352 of FIG. 3B may represent a rate of homeostatic recovery, \dot{S}(t)=A(α−βS), where 0<A≦1, and where A=1 implies no apnea condition is present. In particular embodiments, modification factor A may be equal to, proportional to, or otherwise a function of one or more of an AHI number, a SDI number, a PSQI number, a numerical value associated with a subjective severity assessment, and/or the like. Other embodiments may utilize equivalent optional step-105 modifications to optional step-104 sleep functions to those shown in FIGS. 3A and 3B as are known in the art.

In optional step 106, any additional data that may call for adjustments in the neurobehavioral performance predictions (called “adjustment data” herein, and within the appended claims) output by the neurobehavioral performance model may be received at the processor. Adjustment data refers to any additional information that may be used to improve the accuracy of fatigue predictions and may comprise, by way of non-limiting example, work schedule data, light data (e.g., sunlight levels, indoor/outdoor lighting in work environment etc.), actigraphy data, activity data (e.g., exercise times, driving or commute time data, flying time, etc.), stimulant consumption data (e.g., dosage, stimulant type, and time of ingestion etc.), sleep stressor data (e.g., humidity, temperature, noise, ambient light levels, etc. of the sleeping environment) and/or the like.

Proceeding to optional step 107, neurobehavioral performance assessment results may be received at the processor. Neurobehavioral performance assessment results may comprise results of any neurobehavioral performance test referred to herein or their equivalent, context-relative performance tasks (e.g., the aforementioned workplace specific tasks, line-of-work specific tasks, and special tasks), and/or the like.

In step 108 the step-101 apnea-severity data, the step-102 apnea-treatment data, and, if provided, the optional step-103 sleep data, the optional step-104 processed sleep function, the optional step-105 modified sleep function, the optional step-106 adjustment data, and the optional step-107 neurobehavioral performance assessment results are input into a neurobehavioral performance model, and a neurobehavioral performance prediction (NBP_{P}) is then provided as output. Step-108 neurobehavioral performance predictions (NBP_{P}) may comprise a predicted general alertness or fatigue level (e.g., high, medium, or low, etc.), a predicted score on a fatigue-alertness scale (e.g., a 58 on a scale from 0 to 100, etc.), a contextual performance metric, a normalized contextual performance metric, a performance rating on a workplace-specific task, a performance rating on a standardized line-of-work specific task, a performance rating on a special task, a result metric on a neurobehavioral performance test, a result metric on a stimulus-response test, a result metric on the Psychomotor Vigilance Test, and/or the like. For a non-limiting example of a contextual performance metric, see Mollicone, D. J., and Mott, C. G., Systems and Methods for Fatigue-Risk Assessment Using Historical Incident Data, U.S. patent application Ser. No. 13/235,956. For a non-limiting example of a normalized contextual performance metric, see Mollicone, D. J., Mott, C. G., and Kan, K. G. W., A Normalized Contextual Performance Metric for the Assessment of Fatigue-Related Incidents, U.S. patent application Ser. No. 13/370,288. Particular embodiments of the invention may make use of any one or more of the devices or technologies described in the aforementioned references or various combinations and/or variations thereof. All of the publications referred to in this paragraph are hereby incorporated by reference herein.

FIG. 1B provides a method 100B for managing discrepancies between method-100A predicted neurobehavioral performance levels (NBP_{P}) and independently measured or received actual neurobehavioral performance levels (NBP_{A}). Method 100B provides additional steps beyond method 100A in which actual neurobehavioral performance measurements (NBP_{A}) are received at the processor in step 120 and compared, in step 121, to the predicted neurobehavioral performance (NBP_{P}) provided as output from method 100A. Step-120 measured (or actual) neurobehavioral performance NBP_{A} may be received at the processor by applying a neurobehavioral performance assessment to the testing subject 110 and inputting the results. The neurobehavioral performance assessments used in step 120 may comprise any neurobehavioral performance test referred to herein or their equivalent, context-relative performance tasks (e.g., workplace specific tasks, line-of-work specific tasks, and special tasks), neurobehavioral assessments derived from embedded systems (e.g., driving task monitors, etc.) and/or the like. Ideally the step-120 neurobehavioral performance measurement is taken with regard to the same neurobehavioral model and/or the same neurobehavioral performance assessment as used in step 108 of method 100A. Particular embodiments, however, may use translational tools as necessary to convert a measured neurobehavioral performance assessment from step 120 into a form suitable for comparison to a step-108 predicted neurobehavioral performance level when different neurobehavioral performance models are used.

If the step-121 comparison between NBP_{A} and NBP_{P} (i.e. ΔNBP=|NBP_{P}−NBP_{A}|) is not zero (or otherwise above a particular non-zero threshold), then method 100B may proceed along any one or more of four process-flow paths—depending upon the decisions or assumptions made by an administrative user 111 (or other equivalent administrative operational system, network, device, method, algorithm, and/or the like) of the disclosed invention—as follows:
the step-101 apnea-treatment program is either not being followed by, or is insufficient to treat, the testing subject 110, in which case process flow proceeds to sub-method 130 (Apnea Treatment Compliance Assessment Sub-Process) of FIG. 1C;
the step-102 apnea-treatment data is not accurate, in which case process flow proceeds to sub-method 140 (Apnea Severity Assessment Sub-Process) of FIG. 1D;
the optional step-103 sleep data is not accurate, in which case process flow proceeds to sub-method 150 (Predicted Sleep Assessment Sub-Process) of FIG. 1E; or
the parameters used by the step-108 biomathematical performance model need adjustment and/or individualization specific to the testing subject 110, in which case flow proceeds to sub-method 160 (Nuerobehavioral Performance Model Parameter Assessment Sub-Process) of FIG. 1F.

Alternatively, nothing may need to be done, (i.e., a no-action step is taken, but not shown in FIG. 1B), before method 100B terminates.

Administrative user 111 may comprise a personnel or operational manager, a medical professional, a military commander, and/or one or more other human agents capable of independent decision-making, but may also comprise a computer, device, network, algorithm, or other system capable of selecting one or more of sub-processes 130, 140, 150, and 160 based upon the step-121 comparison of step-108 predicted neurobehavioral performance and step-120 actual (or measured) neurobehavioral performance, either by intervention of human intelligence or by an algorithm-driven selection process.

In the event that administrative user 111 decides that it is the step-102 apnea treatment data that is causing discrepancies between the predicted 209 and measured 221 neurobehavioral performance levels, method 100B proceeds through sub-process 130 of FIG. 1C. Sub-process 130 commences in step 131, wherein apnea-treatment compliance data is received. Step-131 of method 130 is identical to step-131 of method 100, discussed previously.

In step 132, a comparison between the step-102 received apnea-treatment data and the step-131 received apnea compliance data is made. The step-132 comparison permits an assessment of the treatment program and/or the compliance with the treatment program by subject 110. Step 132 permits an assessment of whether or not (and to what degree) user subject 110 is adhering to a prescribed apnea treatment program. Results of the comparison may comprise a binary complaint-vs.-noncompliant decision, a percentage compliance assessment, a determination of a particular threshold of compliance (e.g., device worn at least 75% of the prescribed time, etc.), a time series of such assessments (e.g., one for each night or each hour of every day under consideration), and/or the like.

If results of the step-132 comparison indicate non-compliance with a treatment program where compliance was assumed in method 100A because step-132 received compliance data was not previously received during method 100A, method 100A and/or method 100B may be rerun with the step-132 received compliance data.

In optional step 134, furthermore, a report may be made to appropriate personnel (e.g., medical, administrative, military command, etc.) as to whether the treatment program indicated by the step-102 received apnea-treatment data is being followed. The step-134 report may be a simple alert of noncompliance (e.g., a Boolean flag), or may contain one or more results of the step-132 comparison.

If, on the other hand, results of the step 132 comparison indicate a compliance status (i.e., the device use indicated by step-102 received apnea treatment data is being followed, per the step-131 apnea-treatment compliance data) the foregoing results of the step-132 comparison may then be utilized to make adjustments in the treatment program, if needed, or to report noncompliance (or compliance) by subject 110 to appropriate authorities. For example, in optional step 133 modifications to the treatment program can then be made. Step-133 modifications may include, but are not limited to, prescribing additional CPAP or other treatment device use, changes to medication prescriptions, additional instructions regarding sleep time (or position, inclination, location, setting, etc.) and/or the like. According to other embodiments, appropriate personnel are notified that a proposed change to the apnea treatment plan indicated by step-102 received apnea treatment data may be in order.

In the event that an administrative user decides that the step-101 apnea-severity data needs to be adjusted in order to reduce the discrepancies between the predicted 209 and measured 221 neurobehavioral performance levels, method 100B proceeds through sub-process 140 of FIG. 1D. Sub-process 140 commences with step 141, in which the severity data is modified to account for the difference between predicted and measured neurobehavioral performance. Step-141 modification may comprise, by way of non-limiting example, rerunning different apnea-severity data through the neurobehavioral performance model 208 being used until the discrepancies between the predicted and measured neurobehavioral performance levels are reduced or eliminated. Step-141 modification may also involve, without limitation, applying a set of heuristic rules (or “rules of thumb”) to reduce the discrepancies (e.g., increase the AHI by 1 point for every 3% difference in predicted versus measured neurobehavioral performance level at a specified time of day, etc.).

In optional step 142, appropriate medical, professional, administrative or command personnel may be notified that a change has been made in subject 110's apnea severity data, and that medical and/or other professional review or the like may be required.

For the particular embodiments that involve receiving sleep data in optional step 103, it may routinely be the case that such step-103 received sleep data is not accurate—because, e.g., logs were improperly kept, memories were inaccurate, forms were filled out illegibly, records were falsified, and/or the like. To the extent that administrative user 111 may determine that it is the optional step-103 sleep data that is causing discrepancies between the predicted and measured neurobehavioral performance levels, method 100B may then proceed through sub-process 150 of FIG. 1E so that a more accurate future sleep prediction may be made.

Sub-process 150 commences with step 151 wherein sleep-history data is received. Step-151 received sleep-history may include not only the same sleep data as received in optional step-103, but also any additional sleep-history data, or any other information from which sleep-history may be derived (e.g., actigraphy, activity logs, etc.) In particular embodiments step-151 provided sleep-history data reflects a different sleep history (e.g., different time intervals under consideration, overlap between time intervals considered, different source of sleep data, and/or different sleep status reports, etc.) than the sleep data received in step 103. For other particular embodiments, the two sleep histories are the same.

A sleep prediction model is then provided in step 152. A step-152 provided sleep prediction model accepts step-151 received sleep-history data as input and predicts future sleep intervals based upon sleep/wake patterns and other methods and/or techniques for sleep prediction. A step-152 sleep-prediction model may comprise sleep/activity pattern recognition techniques, heuristic rules describing typical or population-specific sleep patterns (e.g., an eight-hour sleep interval occurs two hours before every eight-hour work interval, certain medical professionals experiencing 24 hour wake periods every 36 hours, etc.), and/or the like.

In step 153, the step-152 sleep-prediction model is applied to the step-151 sleep-history data to predict one or more prospective future sleep schedules. A step-153 future sleep schedule provides details, e.g. (without limitation), as to when subject 110 will sleep, for how long, estimated wake times, estimated sleep times, and/or the like.

With the step-153 predicted future sleep schedule, another prediction of the neurobehavioral performance of subject 110 is run in step 154 using the same neurobehavioral performance model (and other inputs) from step 108. The same (or a substantially similar) process to that utilized in step 108 is utilized in step 153, according to particular embodiments. Step-154 re-run neurobehavioral performance prediction may take any of the same forms as a step-108 predicted neurobehavioral performance (NBP_{P})

The step-154 re-run neurobehavioral performance assessment prediction (NBP_{P}) is then compared in step 155 to the measured neurobehavioral performance assessment (NBP_{A}) from step 120. If the step-155 comparison is not zero (or otherwise above a non-zero threshold) (step 155 NO branch), flow of sub-process 150 then proceeds to step 156 where further adjustments are made to step-151 received sleep-history data as needed. Step-156 adjustments may comprise application of heuristic rules, statistical regression techniques, data fitting techniques, and/or the like. With newly adjusted step-151 sleep-history data, sub-process 150 loops through steps 153 (predict future sleep schedule), 154 (re-run step-108 NBP_{P}), 155 (compare NBP_{P} to NBP_{A}), until the step 155-comparison is zero (or otherwise below a non-zero threshold).

Upon achieving a zero-valued step-155 comparison (step 155 YES branch), sub-process 150 terminates.

In the event that administrative user 111 decides that one or more parameters of the neurobehavioral performance model 208 (used in step 108 of method 100A) are causing discrepancies between the predicted 209 and measured 221 neurobehavioral performance levels, method 100B proceeds through sub-process 160. Sub-process 160 commences in step 161 wherein the neurobehavioral performance model used in step 108 of Method 100 is provided. The step-108 neurobehavioral performance model is the model responsible for the predicted neurobehavioral performance level NBP_{P}. In step 162, one or more parameters of the neurobehavioral performance model used in step 108 of method 100 is adjusted so as to eliminate or to reduce the discrepancies between the (step-108) predicted and the (step-120) actual neurobehavioral performance levels. Step-162 parameter adjustment may comprise one or more of: rerunning one or more step-108 prediction steps using different neurobehavioral performance model parameters until the discrepancies disappear (e.g., by trial-and-error, by systematic alteration across all ranges of parameter values, etc.), applying a heuristic rule (or “rule of thumb”—e.g., reduce ρₛ for every 2% of performance overestimation, etc.) to the parameters of the step-108/step-160 neurobehavioral performance model, and/or the like. Within the two-process model of alertness, non-limiting examples of parameters to the step-108/step-160 neurobehavioral performance model include: φ (the circadian phase offset), γ (the circadian amplitude), τ (the circadian period), aₗ (Fourier-series coefficients for the higher-order harmonic oscillations in alertness), ρ_{w} (the time constant for the build-up of the homeostatic process during wakefulness), ρₛ (the time constant for the recovery of the homeostatic process during sleep), κ (C-process-to-S-process scaling factor), ε (an arbitrary, time-varying noise component in alertness), and/or the like. Other biomathematical models, neurobehavioral performance models, and/or fatigue models will have their own model-specific parameters that may be adjusted in step 162, according to particular embodiments.

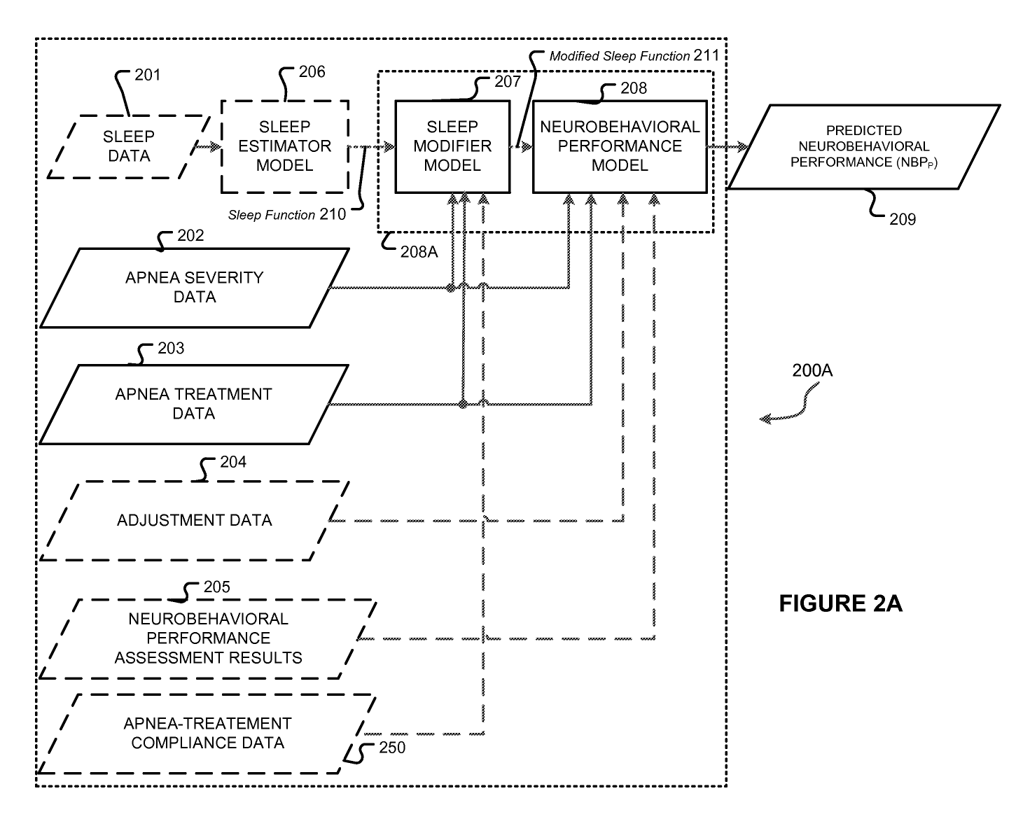

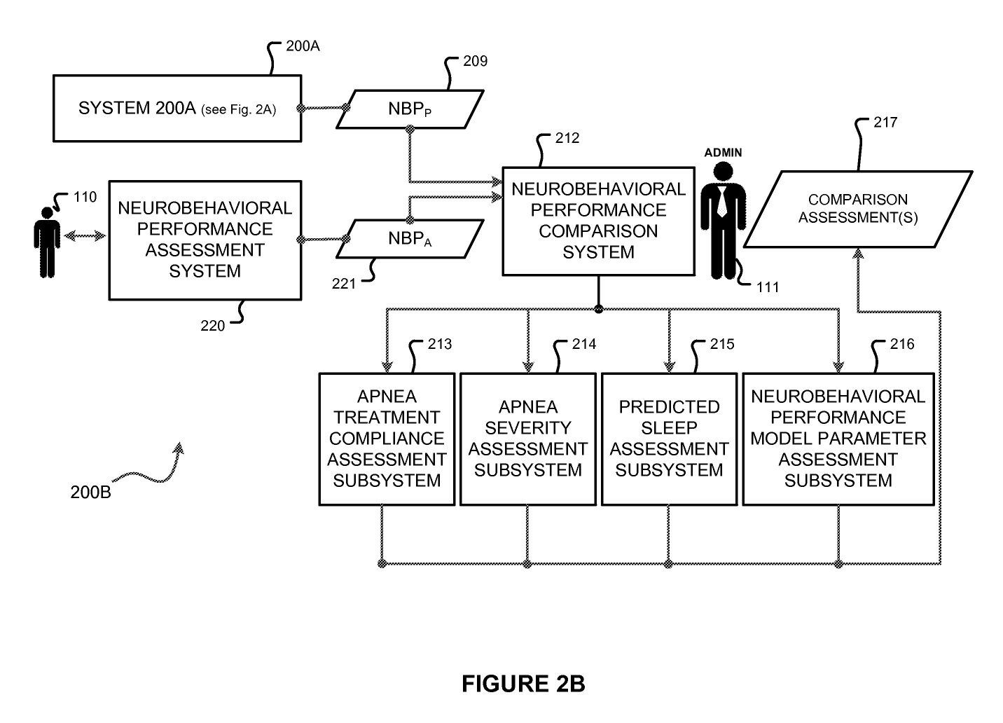

FIG. 2A provides an exemplary system 200A on which method 100A can be executed, in accordance with particular embodiments. System 200A comprises several data input records—specifically: (optional) sleep data 201, apnea-severity data 202, apnea-treatment data 203, (optional) adjustment data 204, and (optional) neurobehavioral performance assessment results 205.

Sleep data 201 may comprise any data capable of revealing the sleep history and/or future sleep schedule of subject 110, and may comprise, without limitation, sleep history data, future sleep schedule data, sleep intervals derived from work schedules or other planned activity, sleep journal entries, actigraphy data processed for sleep-interval identification, and/or the like.

Apnea-severity data 202 may comprise any data capable of describing the severity of an apnea condition suffered by subject 110, and may comprise, without limitation, an AHI number, an SDI number, a PSQI number, subjective severity assessments (e.g., scale of 1 to 10, a rating of “high,” medium,” or “low” etc.), and/or the like.

Apnea-treatment data 203 may comprise any data capable of reflecting one or more treatment regimens undergone by subject 110 to treat an apnea condition, and may comprise, without limitation, schedule or use details for a CPAP or other device, instructions to modify sleep position, duration or times, etc., a prescription for medications, and/or the like.

Adjustment data 204 may comprise any additional data that may call for adjustments in the neurobehavioral performance predictions (called “adjustment data” herein, and within the appended claims) output by the neurobehavioral performance model may be received at the processor. Adjustment data 204 refers to any additional information that may be used to improve the accuracy of fatigue predictions and may comprise, by way of non-limiting example, work schedule data, light data (e.g., sunlight levels, indoor/outdoor lighting in work environment etc.), actigraphy data, activity data (e.g., exercise times and intensities, driving or commute time data, flying time, etc.), stimulant consumption data (e.g., dosage, stimulant type, and time of ingestion etc.), sleep stressor data (e.g., humidity, temperature, noise, ambient light levels, etc. of the sleeping environment) and/or the like.

Neurobehavioral performance assessment results 205 may comprise results of any neurobehavioral performance test referred to herein (or their equivalent), context-relative performance tasks (e.g., workplace specific tasks, line-of-work specific tasks, and special tasks etc.), neurobehavioral performance assessments received from embedded measurement systems, and/or the like.

System 200A also comprises a sleep estimator model 206, a sleep modifier model 207, and a neurobehavioral performance model 208, 208A. Sleep estimator model 206 is capable of creating a sleep function 210 from sleep data 201 and may comprise any technique for converting the sleep data 201 into sleep function 201, such as (without limitation) heuristic rules, pattern identification techniques, and/or the like. Sleep modifier model 207 comprises one or more components and/or systems capable of modifying sleep data 201 and/or sleep function 210 to account for the presence of sleep apnea in the subject, as indicated by apnea severity data 202. Specific techniques by which sleep modifier model 207 operates are detailed in FIGS. 3A and 3B.

Neurobehavioral performance model 208 comprises any biomathematical model capable of predicting neurobehavioral performance including, but not limited to, the two-process model of alertness, the three-process model of alertness, the two-process model revisited, the process-U model, the modified two-process model, the QinetiQ approach, the circadian alertness simulator, the new model class, alternative models such as nonparametric approaches and neural networks, any and all equivalents of the foregoing, and/or the like.

Conceptually sleep modifier model 207 may be a separate, standalone component to neurobehavioral performance model 208, in accordance with particular embodiments, or it may be incorporated as a specific component or module to a neurobehavioral performance model 208A, in accordance with other particular embodiments (the difference being largely theoretical).

System 200A also comprises an exemplary output data field 209 that provides a neurobehavioral performance prediction (NBP_{P}). Neurobehavioral performance prediction 209 may comprise a general fatigue or alertness level, a score on a fatigue-alertness scale, a contextual performance metric, a normalized contextual performance metric, a performance rating on a specific task, a result metric on a neurobehavioral performance test, a result metric on a stimulus-response test, a result metric on the Psychomotor Vigilance Task, and/or the like.

During operation of system 200A (such as during execution of process 100A), optional sleep estimator model 206 accepts sleep data 201 as input and provides a sleep function 210 to sleep modifier model 207. Sleep function 210 provides a numerical or other mathematical representation of the sleep schedule of testing subject 110 over a time period of interest—whether past, present, future, or some combination thereof—for which neurobehavioral performance predictions 209 are sought. Accepting as inputs sleep function 210 along with apnea-severity data 202 and apnea-treatment data 203, sleep modification model 207 modifies sleep function 210 to account for the existence and severity of apnea (or other sleep-disordered breathing) and any treatment plans indicated by apnea-treatment data 203.

Similarly FIG. 2B extends system 200A (of FIG. 2A) with additional components used to carry out method 100B (of FIG. 1B) on system 200B, according to particular embodiments. A neurobehavioral performance measurement system 220 is provided in system 200B, is capable of carrying out a neurobehavioral performance assessment on subject 110, and may comprise any one or more of: a neurobehavioral performance testing system (e.g., PVT test equipment, NeuroCATS battery system, and/or the like), an embedded neurobehavioral performance monitoring system (e.g., automated lane tracking technology for automotive and/or trucking applications), a context-relative performance task measurement system (e.g., workplace specific task measurement system, line-of-work specific task measurement system, special task measurement system, and/or the like), and/or the like. Neurobehavioral performance assessment system 220 generates a neurobehavioral performance assessment 221 corresponding to the actual neurobehavioral performance (NBP_{A}) of subject 110 as measured by assessment system 220.

A neurobehavioral performance comparison system 212 is also provided in system 200B, is capable of comparing the system-200A predicted neurobehavioral performance (NBP_{P}) with the system-220 actual neurobehavioral performance (NBP_{A}), and may comprise any system, device, computer, network, and/or the like capable of suitable data comparison under such circumstances.

To carry out sub-processes 130, 140, 150, and 160 of FIG. 1B, system 200B is provided with subsystems 213 (Apnea Treatment Compliance Assessment Subsystem), 214 (Apnea Severity Assessment Subsystem), 215 (Predicted Sleep Assessment Subsystem), and 216 (Neurobehavioral Performance Model Parameter Assessment Subsystem), respectively. Subsystems 213, 214, 215, and 216 may comprise any suitable computing device capable of carrying out such sub-processes and, furthermore, may comprise the same processor, device, computer, network, and/or the like for all subsystems 213, 214, 215, and 216. Output from one or more of subsystems 213, 214, 215, and 216 may be presented to an administrative user 111 in the form of a comparison assessment 217. Comparison assessment 217 may comprise any one or more of the output options of subsystems 213, 214, 215, and 216, including without limitation one or more of: (from sub-process 130) a step-132 comparison of step-102 apnea treatment data to step-131 apnea treatment compliance data, a step-133 modified apnea treatment program, and a step-134 apnea treatment program compliance report; (from sub-process 140) a step-141 adjusted apnea severity data, and a step-141 apnea treatment review program flag; (from sub-process 150) a step-153 predicted future sleep schedule, a step-154 re-run step-108 neurobehavioral performance prediction, and a step-155 comparison of a step-154 neurobehavioral performance prediction and a step-120 actual neurobehavioral performance assessment; and (from sub-process 160) one or more step-162 adjusted parameters of a neurobehavioral performance model.

Sleep Function Modification

Embodiments of the presently disclosed invention may modify or otherwise alter sleep function 210 to account for the presence and severity of apnea (or a course of apnea treatment) in subject 110. Sleep modifier model 207 is responsible for carrying out any modifications to the sleep function 210. Output of sleep modifier model 207 is modified sleep function 211.

The multiple views of FIG. 3 illustrate two non-limiting and non-exclusive approaches for sleep modifier model 207 to modify sleep function 209 according to step-101 received apnea-severity data, according to particular embodiments. In the non-limiting case that step-101 received apnea-severity data comprises an AHI number, sleep modifier/module 207 may accept a continuous sleep function over a time interval and introduce apnea events into the sleep function sufficient to match the AHI number. FIG. 3A illustrates a hypothetical sleep function 210 comprising an idealized square wave signal 300, according to particular embodiments, reflecting that an apnea-afflicted subject 110 is asleep for a one-hour interval and awake the remaining time. According to particular embodiments, sleep modifier model 207 introduces an apnea event in the form of a short wake episode 302 (resembling a slender “notch”) in signal 301 during the sleep interval. Wake period 302 could be set at a fixed short time interval (approximately 10 seconds or so) or vary according to the step-101 received apnea data (where duration of a wake period 302 may, e.g., be proportional to AHI but bounded within a small range). According to particular embodiments, the number of wake periods 302 introduced by sleep modifier model 207 corresponds to the AHI number minus 1, on the assumption that the final wake event was caused by an apnea. In other embodiments, the number of wake periods 302 introduced by sleep modifier model 207 equals the AHI number, on the assumption that the final wake event was not caused by an apnea. In other embodiments the number is proportional to the AHI number, a function of the AHI number, and/or the like. Other embodiments use SDI, PSQI, and/or numerical versions of subjective severity assessments (e.g., rating of 1 to 10, etc.) in similar fashion as a replacement for the AHI number.

FIG. 3B provides another non-limiting example of how sleep modifier model 207 modifies a sleep function 210, when the sleep function 210 is provided as a rate of sleep recovery, according to particular embodiments. Function 351 represents the rate of homeostatic recovery, \dot{S}(t), during an eight (8) hour sleep interval for a normal (non-apnea afflicted) individual. In generalized form the rate of homeostatic recovery may be represented as:

\dot{S}(t)=A(α−βS) (7)

where α and β are arbitrary constants (α=1, shown in FIG. 3B), S represents the homeostatic component of alertness, and A is a constant proportional to the apnea severity (A=1 for “normal” sleep without apnea; and 0<A<1 for an apnea condition). Function 352 represents the rate of recovery \dot{S}(t) of the homeostatic component of alertness for an apnea-afflicted subject over the same time interval in which the rate of homeostatic recovery is impaired due to apnea events. The aggregate homeostatic recovery for a time interval can be calculated by taking an integral of sleep function 351 over the time interval in question (e.g., integrating over the variable t between t₀ and t₁, as shown in FIG. 3B).

As other non-limiting examples, the multiple views of FIG. 5 provide plots of modified sleep functions 211 corresponding to differing apnea-severity data, in accordance with particular embodiments. The top graph, of FIG. 5A, shows a (modified) sleep function 501 corresponding to an hour of sleep with no arousal events, which represents a person without any degree of sleep apnea. Modified sleep function 501 is “modified” in the sense that it has been operated on by sleep modifier model 207, even though no apnea events were added to it because the AHI is zero. (As used throughout herein, a graph point at the number “1” indicates by convention that the subject is asleep, whereas a graph point at the number “0” indicates by convention a period of wakefulness.) The second graph, of FIG. 5B, shows a modified sleep function with simulated arousal events for a person with an AHI of five indicating that the subject wakes up five times during the hour of sleep indicated. (The fifth arousal event occurs at the end of the hour of sleep.) The third graph, of FIG. 5C, shows a modified sleep function 503 with simulated arousal events for a subject with an AHI of twenty-five, and the last graph, of FIG. 5D, shows a modified sleep function 504 with simulated arousal events for a subject with an AHI of forty-five. Each sleep function has the corresponding number of “notches” (minus one, representing the final wake episode, in accordance with particular embodiments).

One advantage of modeling sleep of the subject 110 in the manner of FIGS. 5A-5D is that the neurobehavioral performance model 208, 208A may then calculate the effects of subject 110 getting a lesser amount of sleep due to fragmentation but does not have the undesirable effect of modifying the circadian phase offset (i.e., φ of Equation 1, above, within the two-process model) of the subject 110. That is to say, sleep duration is effectively lessened, but the wake time remains unchanged. If, instead, the amount of sleep was just shortened based on a sleep apnea factor, the circadian phase offset would not be in alignment with the time period that subject 110 actually spent sleeping—i.e., either the time to sleep or wake time would be altered (thus altering the circadian offset φ. The approach taken in the multiple views of FIG. 5 is therefore compatible with most current models of sleep-recovery processes (a specific subclass of fatigue models) because the models are not sensitive as to the different sleep stages and can therefore accommodate brief wake periods as a means to model disrupted sleep.

Furthermore, sleep modifier module 207 may take into account the effect of an apnea treatment program and whether or not it is being complied with. As such, apnea treatment data 203 and apnea-treatment compliance data 201 may be used to determine when and when not to use a sleep-function modification technique. If the apnea treatment data 203 indicates that a particular treatment is prescribed (e.g., CPAP use), sleep modifier module 207 may not modify the sleep function during periods in which such treatment is prescribed and modify the sleep function only for those times when no treatment is prescribed. Sleep modifier module 207 may also, based upon the apnea-treatment compliance data 210, not modify the sleep function during periods of prescribed treatment if it is revealed that treatment was not complied with.

### Worked Numerical Examples

The multiple views of each of FIGS. 6, 7, and 8 provide several numerically worked examples of how a neurobehavioral performance model—specifically, the Borblèy two-process model of alertness prediction—may be applied to the modified sleep functions 501, 502, 503, 504 from the multiple views of FIG. 5 to arrive at apnea-adjusted fatigue predictions. As a non-limiting example of the output 209 (i.e., predicted neurobehavioral performance, NBP_{P}) from a neurobehavioral performance model 208, 208A the multiple views of FIG. 6 show exemplary plots of fatigue-risk scores derived from the modified sleep functions 501, 502, 503, 504 in accordance with the sleep-function modification technique of FIG. 3A, according to particular embodiments.

By way of summary comparison, the multiple views of FIG. 7 are derived by applying neurobehavioral performance model 208 to the unmodified versions of sleep functions 501, 502, 503, 504 in the multiple views of FIG. 5 using the step-101 received apnea severity data 203 (i.e., the corresponding AHI numbers) as a parameter in model 208, 208A to adjust the rate of sleep recovery in accordance with the sleep-function modification technique of FIG. 3B, in accordance with particular embodiments.

Also by way of summary comparison, the multiple views of FIG. 8 provide another exemplary output 209 (i.e., NBP_{P}) of neurobehavioral performance model 208 in the form of numerical fatigue risk scores calculated with model 208—with FIGS. 8A and 8B utilizing the sleep-modification techniques of FIG. 3A (on two distinct work-day periods), and with FIG. 8C utilizing the sleep-modification techniques of FIG. 3B, in accordance with particular embodiments respectively.

Returning in depth to the multiple views of FIG. 6, exemplary dithered regions 621 and cross-hatched regions 622 indicate intervals where subject 110 is asleep. (Unshaded regions correspond to wake periods.) Cross-hatched regions 622 indicate that subject 110 is complying with an apnea treatment program (e.g., wearing a CPAP device while sleeping, taking medications, sleeping in a prescribed position or inclination, etc.). Dithered regions 621 conversely indicate that subject 110 is not complying with prescribed treatment while sleeping. In the top graph, of FIG. 6A, the AHI is assumed to be zero, and the modified sleep function 211 that is input into the neurobehavioral performance model 208 fatigue-risk predictions 601 is, in fact, the modified sleep function 501 (of FIG. 5A). For each one of the sleep periods—whether hatched/compliant periods 622 or dithered/non-compliant periods 621—subject 110 recovers an equal amount of fatigue risk because no apnea condition is present (i.e., AHI=0).

Modified sleep functions 502 (FIG. 5B, where AHI=5), 503 (FIG. 5C, where AHI=25), and 504 (FIG. 5D, where AHI=45) are input into neurobehavioral performance model 208 to generate the fatigue-risk predictions 602 (FIG. 6B), 603 (FIG. 6C), and 604 (FIG. 6D), respectively. A visible pattern emerges within fatigue-risk predictions 602, 603, and 604. For each sleep period 621 (dithered) where subject 110 is not complying with his/her apnea treatment program, the fatigue-risk recovery achieved by each sleep period 621 is diminished an amount proportional to the severity of the corresponding apnea condition. For the non-compliant sleep periods 621, less fatigue-risk recovery is illustrated in plot 602 than plot 601; less recovery is illustrated in plot 603 than plot 602; and less recovery is illustrated in plot 604 than plot 603.

Conversely, the fatigue-risk level of subject 110 is brought back down to a baseline level of approximately 4 after the second of two compliant sleep periods 622 (cross-hatched), regardless of apnea-severity data 203 (i.e., AHI) in each of fatigue-risk predictions 601, 602, 603, and 604. Such an outcome tends to indicate that the apnea treatment program is adequate to address subject 110's apnea condition.

The multiple views of FIG. 7 illustrate similar fatigue-risk predictions as those illustrated in the multiple views of FIG. 6. The plots of FIG. 7, however, are generated in accordance with the sleep-modification technique of FIG. 3B, wherein the apnea-severity data 203 (specifically the AHI number) is used as a parameter to neurobehavioral performance model 208, instead of being used as a parameter to sleep-modification model 207. To with, the AHI number for each of FIGS. 7A, 7B, 7C, and 7D are used as the “A” parameter in the formula for rate of sleep recovery—i.e., \dot{S}(t)=A(α−βS)—of Equation 7, above. Trends within the multiple plots of FIG. 7 are therefore similar to the trends within the multiple plots of FIG. 6—i.e., diminishing fatigue-risk recovery with increasing apnea severity, and a return to a baseline fatigue-risk score of approximately 4 after the second of two consecutive compliant sleep intervals 622 regardless of apnea severity. Comparison of the multiple plots from FIGS. 6 and 7 therefore supports the notion that the sleep-modification techniques of FIGS. 3A and 3B are roughly interchangeable. The presently disclosed invention is designed to use either technique, as well as any suitable equivalent sleep-function modification technique known or yet to be discovered in the art.

Neurobehavioral performance model 208 might also output a single number representing a fatigue-risk score as the predicted neurobehavioral performance (NBP_{P}) 209. As such, the multiple views of FIG. 8 illustrate how such a single-valued-score approach works. FIG. 8A provides an example of single-valued scores that might be generated according to particular embodiments. The single-value score may comprise one or more of: average daily or hoursly model-predicted score, minimum or maximum daily or hourly model-predicted score, and/or the like. The conditions used to generate the scores of FIG. 8A are the same as those used to generate the plots found in FIG. 6, namely: i) each night of sleep is assumed to last eight hours; ii) subject 110 is assumed to be compliant with CPAP treatment only on the fourth and fifth nights; iii) on the nights subject 110 is compliant, it is assumed that the compliance level and treatment efficacy is one-hundred percent; iv) on the nights subject 110 was non-compliant, the sleep input is modified to simulate arousal events caused by sleep apnea; and v) on each of the seven days represented, subject 110 is assumed to be working for ten hours, from three hours after wake until three hours before sleep.

One way that the fatigue-risk scores might be calculated is by averaging the time-varying fatigue-risk prediction plots (such as fatigue-risk predictions 601, 602, 603, 604, 701, 702, 703, and 704) over a wake period. The active period might be defined as the period of time that subject 110 is awake, the period of time that subject 110 is scheduled to work, the period of time that subject 110 is scheduled to perform an especially risky task, any other period of time for which a score is requested, and/or the like. After the average has been calculated, it can be scaled, either linearly or otherwise, to provide a single-valued fatigue-risk score. Additionally, the score might be scaled by the total number of hours worked per day, the total number of hours worked, a generalized scaling factor, and/or the like.

As another example, FIG. 8B provides a series of fatigue-risk scores calculated under the same conditions as those in FIG. 8A except that a longer, twelve-hour work day is assumed within condition v), above. As illustrated in the scores provided, without exception, the longer work day results in a slightly higher fatigue-risk score regardless of apnea severity.

FIG. 8C provides yet another example of a series of fatigue-risk scores—but it provides scores that are calculated using the sleep-function modification technique of FIG. 3B instead. The conditions used to generate the scores of FIG. 8C are the same as those used to generate the multiple plots found in FIG. 7. Each night of sleep was assumed to last eight hours. Subject 110 is assumed to be compliant with CPAP treatment only on the fourth and fifth nights. On the nights that the subject 110 is compliant, it is assumed that the compliance level and treatment efficacy is one-hundred percent. On the nights the person was non-compliant, the fatigue model was modified to simulate worse sleep recovery caused by sleep apnea. On each of the seven days represented, the person was assumed to be working for ten hours, from three hours after wake until three hours before sleep.

Certain implementations of the invention comprise computers and/or computer processors which execute software instructions which cause the processors to perform a method of the invention. For example, one or more processors in a system may implement data processing blocks in the methods described herein by executing software instructions retrieved from a program memory accessible to the processors. The invention may also be provided in the form of a program product. The program product may comprise any non-transitory medium which carries a set of computer-readable instructions that, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Certain implementations of the invention may comprise transmission of information across networks, and distributed computational elements which perform one or more methods of the inventions. Such a system may enable a distributed team of operational planners and monitored individuals to utilize the information provided by the invention. A networked system may also allow individuals to utilize a graphical interface, printer, or other display device to receive personal alertness predictions and/or recommended future inputs through a remote computational device. Such a system would advantageously minimize the need for local computational devices.

Certain implementations of the invention may comprise exclusive access to the information by the individual subjects. Other implementations may comprise shared information between the subject's employer, commander, flight surgeon, scheduler, or other supervisor or associate, by government, industry, private organization, and/or the like, or by any other individual given permitted access.

Certain implementations of the invention may comprise the disclosed systems and methods incorporated as part of a larger system to support rostering, monitoring, selecting or otherwise influencing individuals and/or their environments. Information may be transmitted to human users or to other computerized systems.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components that are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
The systems and methods of various embodiments may be extended to include other measures of human performance such as gross-motor strength, dexterity, endurance, or other physical measures. For example, fatigue may be replaced by one or more other types of neurobehavioral performance such as “sleepiness”, “alertness”, “tiredness”, “cognitive performance”, “cognitive throughput”, and/or the like.
Other models or estimation procedures may be included to deal with biologically active agents, external factors, or other identified or as yet unknown factors affecting alertness/fatigue.

What is claimed is:

1. A method for using a computer to predict the neurobehavioral performance of a subject that accounts for the severity of sleep-disordered breathing in the subject, the method comprising:
receiving apnea-severity data at the computer, the apnea-severity data being indicative of a severity of sleep-disordered breathing in the subject;
receiving apnea-treatment data at the computer, the apnea-treatment data being indicative of one or more sleep-disordered breathing treatments associated with the subject; and
predicting the neurobehavioral performance of the subject, the neurobehavioral performance being indicative of the subject's performance capacity for one or more neurobehavioral tasks;
wherein predicting the neurobehavioral performance of the subject is based at least in part on applying a neurobehavioral performance model to at least one or more of: the received apnea-severity data and the received apnea-treatment data.

2. A method according to claim 1 further comprising:
receiving sleep data at the computer, the sleep data being indicative of a sleep pattern of the subject; and
wherein predicting the neurobehavioral performance of the subject is based at least in part on applying a neurobehavioral performance model to at least one or more of: the received apnea-severity data, the received apnea-treatment data, and the received sleep data.

3. A method according to claim 2 further comprising:
processing the received sleep data into a sleep function, the sleep function being indicative of the subject's sleep state over a time interval of interest.

4. A method according to claim 3 further comprising:
modifying the sleep function based at least in part on the apnea-severity data, the modified sleep function being indicative of reduced sleep efficiency caused by a sleep-disordered breathing condition indicated by the received apnea-severity data.

5. A method according to claim 4 wherein the sleep function is a two-valued square-wave signal over the time interval of interest, and wherein the first value represents a sleep state of the subject, and wherein the second value represents a wake state of the subject.

6. A method according to claim 4 wherein the sleep function comprises a rate of homeostatic recovery for the subject over the time interval of interest.

7. A method according to claim 5 wherein modifying the sleep function comprises inserting short intervals of the first value into at least one long interval of the second value, and wherein the number of short intervals of the first value inserted into the at least one long interval of the second value is determined by the apnea-severity data.

8. A method according to claim 7 wherein the apnea-severity data comprises at least one of: an AHI number, an SDI number, a PSQI number, and a number representing a subjective severity assessment; and wherein the number of short intervals of the first value inserted into the at least one long interval of the second value is a function of at least one of: the AHI number, the SDI number, the PSQI number, or the number representing the subjective severity assessment.

9. A method according to claim 6 wherein the apnea-severity data comprises at least one of: an AHI number, an SDI number, a PSQI number, and a number representing a subjective severity assessment; and wherein modifying the sleep function comprises reducing the rate of homeostatic recovery by a modification factor proportional to the at least one of: the AHI number, the SDI number, the PSQI number, or the number representing the subjective severity assessment

10. A method according to claim 1 further comprising:
receiving adjustment data at the computer, the adjustment data being indicative of factors that affect the subject's neurobehavioral performance, wherein the adjustment data comprises data other than apnea-severity data, apnea-treatment data, or neurobehavioral assessment results; and
wherein predicting the neurobehavioral performance of the subject is based at least in part on applying a neurobehavioral performance model to at least one or more of: the received apnea-severity data, the received apnea-treatment data, and the received adjustment data.

11. A method according to claim 10 wherein receiving adjustment data comprises receiving one or more of the following: sleep history data, future sleep schedule data, activity data, actigraphy, work history data, future work schedule data, sleep stressor data, stimulant consumptions data, sleep survey data, and sleep log entries.

12. A method according to claim 1 further comprising:
receiving one or more neurobehavioral performance assessment results at the computer, the neurobehavioral performance assessment results being indicative of the subject's performance capacity for one or more neurobehavioral tasks, and
wherein predicting the neurobehavioral performance of the subject is based at least in part on applying a neurobehavioral performance model to at least one or more of: the received apnea-severity data, the received apnea-treatment data, and the received neurobehavioral performance assessment results.

13. A method according to claim 12 wherein the one or more neurobehavioral performance assessment results comprise results from one or more of: the Psychomotor Vigilance Test, the Motor Praxis Test, the Visual Object Learning Test, the Fractal-2-Back Test, the Conditional Exclusion Task, the Matrix Reasoning Task, the Line Orientation Test, the Emotion Recognition Task, the Balloon Analog Risk Task, the Digit Symbol Substitution Test, the Forward Digit Span, the Reverse Digit Span, the Serial Addition and Subtraction Task, the Go/NoGo Task, the Word-Pair Memory Task, the Word Recall Test, the Motor Skill Learning Task, the Threat Detect Task, the Descending Subtraction Task, the Positive Affect Negative Affect Scales—Extended Version Questionnaire, the Pre-Sleep/Post-Sleep Questionnaires for Astronauts, the Beck Depression Inventory, the Conflict Questionnaire, the Karolinska Drowsiness Test, the Visual Analog Scales, the Karolinska Sleepiness Scale, the Profile of Mood States Long/Short Form Questionnaire, and the Stroop Test.

14. A method according to claim 1 wherein the apnea-severity data comprises one or more of: an apnea hypopnea index, a respiratory disturbance index, a Pittsburgh sleep quality index, and a subjective severity assessment.

15. A method according to claim 1 wherein the apnea-severity data comprises one or more neurobehavioral performance assessments of the subject.

16. A method according to claim 15 wherein the apnea-severity data comprises a plurality of neurobehavioral performance assessments of the subject taken across a time span of interest.

17. A method according to claim 1 wherein the apnea-severity data is received from one or more of: a polysomnography system, an oximetry system, and an electroencephalography system.

18. A method according to claim 1 wherein the apnea-treatment data comprises one or more of: use/non-use status of an apnea device, time of use of an apnea device, duration of use of an apnea device use, type of apnea device used, sleeping position modifications, sleeping inclination modifications, sleeping duration modifications, time-to-bed modifications, and medications.

19. A method according to claim 1 wherein the apnea-treatment data is received from one or more of: a continuous positive airway pressure device, an automatic positive airway pressure device, a bilevel positive airway pressure device, and an oral appliance therapy device.

20. A method according to claim 1 wherein predicting neurobehavioral performance of the subject comprises predicting one or more of: a general alertness level, a general fatigue level, a score on a fatigue-alertness scale, a contextual performance metric, a normalized contextual performance metric, a performance rating on a workplace-specific task, a performance rating on a standardized line-of-work specific task, a performance rating on a special task, a result metric on a neurobehavioral performance test, a result metric on a stimulus-response test, and a result metric on the Psychomotor Vigilance Test.

21. A method according to claim 12 wherein the one or more neurobehavioral performance assessment results comprise one or more of: results of a workplace-specific task, results of a standardized line-of-work-specific task, and results of a special tasks.

22. A method according to claim 1 further comprising:
measuring the neurobehavioral performance of the subject, the measured neurobehavioral performance being indicative of the actual neurobehavioral performance of the subject; and
determining a comparison of the predicted neurobehavioral performance of the subject to the measured neurobehavioral performance of the subject, the determined comparison being indicative of the accuracy of the predicted neurobehavioral performance with respect to the measured neurobehavioral performance.

23. A method according to claim 22 further comprising:
receiving apnea-treatment compliance data at the processor, the apnea-treatment compliance data being indicative of the subject's behavior with respect to the one or more sleep-disordered breathing treatments associated with the subject;
determining a comparison between the received apnea-treatment compliance data and the received apnea-treatment data, the comparison between the received apnea-treatment compliance data and the received apnea-treatment data being indicative of the subject's compliance with the one or more sleep-disordered breathing treatments associated with the subject.

24. A method according to claim 23 further comprising:
modifying at least one of the one or more sleep-disordered breathing treatments associated with the subject based upon the comparison between the received apnea-treatment compliance data and the received apnea-treatment data.

25. A method according to claim 23 further comprising:
generating a report of the comparison between the received apnea treatment compliance data and the received apnea-treatment data.

26. A method according to claim 22 further comprising:
adjusting the received apnea-severity data based upon the comparison between the received apnea treatment compliance data and the received apnea-treatment data.

27. A method according to claim 26 further comprising:
denoting for medical or professional review at least one of the one or more sleep-disordered breathing treatments associated with the subject based upon the comparison between the received apnea treatment compliance data and the received apnea-treatment data.

28. A method according to claim 22 further comprising:
[a] receiving sleep-history data at the computer, the sleep-history data being indicative of one or more historical patterns of sleep episodes or wake episodes associated with the subject;
[b] predicting one or more future sleep schedules, the future sleep schedules being indicative of a likely future pattern of sleep episodes or wake episodes associated with the subject, and wherein predicting the one or more future sleep schedules is based upon applying a sleep-prediction model to the received sleep-history data; and
[c] determining a revised prediction of the neurobehavioral performance of the subject, the revised prediction being indicative of the predicted neurobehavioral performance of the subject with respect to the predicted one or more future sleep schedules, wherein the revised prediction is based at least in part on applying a neurobehavioral performance model to at least one or more of: the received apnea-severity data, the received apnea-treatment data, and the predicted one or more future sleep schedules.

29. A method according to claim 28 further comprising:
[d] determining a revised comparison between the revised prediction of the neurobehavioral performance of the subject and the measured neurobehavioral performance of the subject, the revised comparison being indicative of the accuracy of the revised prediction of the neurobehavioral performance of the subject with respect to the measured neurobehavioral performance of the subject.

30. A method according to claim 29 further comprising:
[e] adjusting the received sleep history data based at least in part on the determined revised comparison.

31. A method according to claim 30 further comprising:
[f] repeating steps [b] through [d] using the adjusted received sleep-history data.

32. A method according to claim 22 further comprising:
adjusting one or more parameters associated with the neurobehavioral performance model based upon the comparison between the received apnea treatment compliance data and the received apnea-treatment data.

33. A method according to claim 32 wherein the neurobehavioral performance model comprises the Borbèly two-process model.

34. A method according to claim 33 wherein adjusting one or more parameters associated with the neurobehavioral performance model comprises adjusting one or more of: φ, γ, τ, aₗ, S, ρ_{w}, ρₛ, κ, and ε.

35. A system for predicting the neurobehavioral performance of a subject that accounts for the severity of sleep-disordered breathing in the subject, the system comprising:
one or more apnea-severity data records, the apnea-severity data records containing data being indicative of a severity of sleep-disordered breathing associated with the subject;
one or more apnea-treatment data records, the apnea-treatment data records containing data being indicative of one or more sleep-disordered breathing treatments associated with the subject;
a sleep modifier model, the sleep modifier model being capable of generating a modified sleep function, the modified sleep function being indicative of a disrupted sleep pattern associated with the subject for a time of interest as affected by a sleep-disordered breathing condition;
a neurobehavioral performance model for predicting the neurobehavioral performance of the subject, the neurobehavioral performance of the subject being indicative of the subject's performance capacity for one or more neurobehavioral tasks;
wherein the sleep modifier model generates a modified sleep function based at least in part on the apnea-severity data records; and
wherein the neurobehavioral performance model predicts the neurobehavioral performance of the subject based at least in part on the modified sleep function.

36. A system according to claim 35 further comprising a sleep estimation model, the sleep estimation model capable of providing a sleep function to the sleep modification module, the sleep function being indicative of an expected sleep pattern associated with the subject in the absence of a sleep-disturbed breathing condition.

37. A system according to claim 36 wherein the sleep modifier model is integral to the biomathematical performance model.

38. A system according to claim 36 further comprising one or more sleep-data data records, the sleep-data data records containing information reflective of the sleep pattern associated with the subject for a time of interest without being affected by a sleep-disordered breathing condition.

39. A system according to claim 35 further comprising:
one or more adjustment-data data records, the adjustment-data data records containing information pertaining to the fatigue level of the subject other than apnea-severity data, apnea-treatment data, sleep-data, and neurobehavioral performance assessment results; and
wherein the neurobehavioral performance model predicts the neurobehavioral performance of the subject based at least in part on the modified sleep function and the one or more adjustment-data data records.

40. A system according to claim 35 further comprising:
one or more neurobehavioral performance assessment results data records containing results of one or more neurobehavioral performance assessments administered to the subject, the neurobehavioral performance assessment results being indicative of the subject's neurobehavioral performance; and
wherein the neurobehavioral performance model predicts the neurobehavioral performance of the subject based at least in part on the modified sleep function and the one or more performance-data data records.

41. A computer program product embodied in a non-transitory medium and comprising computer-readable instructions that, when executed by a suitable computer, cause the computer to perform a method for predicting the neurobehavioral performance of a subject that accounts for the severity of sleep-disordered breathing in the subject, the method comprising:
receiving apnea-severity data at the computer, the apnea-severity data being indicative of a severity of sleep-disordered breathing in the subject;
receiving apnea-treatment data at the computer, the apnea-treatment data being indicative of one or more sleep-disordered breathing treatments associated with the subject; and
predicting the neurobehavioral performance of the subject, the neurobehavioral performance being indicative of the subject's performance capacity for one or more neurobehavioral tasks;
wherein predicting the neurobehavioral performance of the subject is based at least in part on applying a neurobehavioral performance model to at least one or more of: the received apnea-severity data and the received apnea-treatment data.
